(19) United States
(12) Patent Application Publication
(10) Pub. No.: US 2015/0103258 A1
(43) Pub. Date: Apr. 16, 2015

(54) LIGHTING DEVICE, DISPLAY DEVICE AND TELEVISION DEVICE

(71) Applicant: Sharp Kabushiki Kaisha, Osaka-shi, Osaka (JP)

(72) Inventor: Akira Gotou, Osaka-shi (JP)

(21) Appl. No.: 14/404,071

(22) PCT Filed: Jun. 27, 2013
(86) PCT No.: PCT/JP2013/067636

§ 371 Date: Nov. 26, 2014

(30) Foreign Application Priority Data
Jul. 3, 2012 (JP) 2012-149667

(51) Int. Cl. F21V 8/00

(52) U.S. Cl. CPC G02B 6/009; G02B 6/0085; G02B 6/0073; G02B 6/0083
USPC 348/790; 362/611; 349/65; 362/613

(57) ABSTRACT

A backlight device 12 includes a LED 17, alight guide plate 19 having an end surface as a light entrance surface 19b and a plate surface as a light exit surface 19a, a LED board 18 having a square plate surface that is opposed to the light entrance surface 19b, a board-side connector 22 arranged on the LED board 18, and a heat dissipation member 20. The heat dissipation member 20 has a positioning hole 26 that is through the heat dissipation member 20 and with which the LED board 18 is positioned with respect to the heat dissipation member 20. The heat dissipation member 20 has a hole edge portion around the positioning hole 26 and the hole edge portion includes two sides 26S1, 26S2 constituting a corner portion, and the two sides 26S1, 26S2 are parallel to two sides 18S1, 18S2 of the plate surface of the LED board 18, respectively. The two sides 18S1, 18S2 of the LED board 18 constitute a corner portion of the plate surface of the LED board 18. The positioning hole 26 overlaps the board-side connector 22.

### TECHNICAL FIELD

The present invention relates to a lighting device, a display device and a television device.

### BACKGROUND ART

In recent years, displays in image display devices, such as television devices, are being shifted from conventional cathode-ray tube displays to thin display panels, such as liquid crystal panels and plasma display panels. With the thin displays, thicknesses of the image display devices can be decreased. Liquid crystal panels used for the liquid crystal display device do not emit light. Therefore, liquid crystal display devices including liquid crystal panels require backlight devices. The backlight devices are classified broadly into a direct type and an edge-light type based on mechanisms. For further reduction in thicknesses of the liquid crystal display devices, the edge-light type backlight devices are more preferable. A backlight device disclosed in Patent Document 1 is known as an example of the kind. A lighting device disclosed in Patent Document 2 is known as a lighting device that improves a heat dissipation property and mechanical strength.

### RELATED ART DOCUMENT

### Patent Document

Patent Document 1: Japanese Unexamined Patent Application Publication No. 2010-177190

Patent Document 2: Japanese Unexamined Patent Application Publication No. 2011-129440

### Problem to be Solved by the Invention

In the edge-light type backlight device, light from light sources that are locally arranged in an end portion of the backlight device is guided by the light guide plate to obtain planar exit light. Therefore, if any variation occurs in positional relation of the light sources with respect to the light guide plate, light use efficiency may be decreased or brightness unevenness may occur in the exit light. Especially, as the backlight device becomes thinner, the positional relation of the light sources with respect to the light guide plate tends to be required to be matched at high precision and therefore, it is difficult to deal with the above matters.

### DISCLOSURE OF THE PRESENT INVENTION

A technology disclosed herein was made in view of the above circumstances. An object is to improve light use efficiency and reduce occurrence of unevenness in brightness.

### Means for Solving the Problem

A technology disclosed herein relates to a lighting device including a light source, alight guide plate having an end surface as a light entrance surface and a plate surface as a light exit surface, a light source board, a power feed relay portion, and a heat dissipation member. Light from the light source enters the light guide plate through the light entrance surface and the light exits the light guide plate through the light exit surface. The light source board has a plate surface where the light source is arranged and that is opposed to the light entrance surface and has a square shape. The power feed relay portion is arranged on the light source board and relays power feed to the light source. The light source board is arranged on the heat dissipation member and the heat dissipation member is configured to dissipate heat generated from the light source. The heat dissipation member has a positioning hole that is through the heat dissipation member and with which the light source board is positioned with respect to the heat dissipation member and the positioning hole corresponds to the power feed relay portion. The heat dissipation member has a hole edge portion around the positioning hole and the hole edge portion includes two sides constituting a corner portion, and the two sides are parallel to two sides of the plate surface of the light source board, respectively. The two sides of the light source board constitute a corner portion of the plate surface of the light source board.

With such a configuration, the light source arranged on the light source board emits light with the power feed relayed by the power feed relay portion. The light emitted from the light source enters the light guide plate through the light entrance surface that faces the light source and travels within the light guide plate and exits the light guide plate through the light exit surface. The light source generates heat according to the light emission. However, the heat from the light source is transmitted to the heat dissipation member via the light source board to be released.

The light source board is mounted on the heat dissipation member so that the two sides constituting one corner portion of the plate surface of the light source board are parallel to the respective two sides constituting one corner portion of the hole edge portion of the positioning hole. Thus, the light source board is mounted on the heat dissipation member so as to be positioned optimally with respect to the heat dissipation member in a direction along the plate surface of the light source board. Accordingly, a mounting error that may be caused between the light source board and the heat dissipation member is decreased and a positional error that may be caused between the light entrance surface and the light source with respect to a direction along the light entrance surface of the light guide plate is decreased. Therefore, the light entrance efficiency of light emitted from the light source and entering the light guide plate through the light entrance surface is improved and brightness unevenness is less likely to be caused in the exit light exiting the light guide plate through the light exit surface. Further, the positioning hole is through the heat dissipation member. Therefore, when the light source board is mounted on the heat dissipation member, the positional relation between the two sides constituting the corner portion of the hole edge portion of the positioning hole and the two sides constituting the corner portion of the plate surface of the light source board can be easily recognized according to light passing through the positioning hole. Accordingly, the light source board is positioned with high accuracy.

As described before, the heat dissipation member has the positioning hole that is therethrough, and the heat dissipation property is deteriorated locally in the portion of the heat dissipation member where the positioning hole is formed. On the light source board that is mounted on the heat dissipation member, the power feed relay portion is arranged on a portion of the light source board corresponding to the positioning hole. Therefore, the light source is arranged not to overlap the positioning hole and the heat generated from the light source can be released effectively via the heat dissipation member even with the positioning hole. The power feed relay portion causes a relatively small amount of heat generation compared to the light source. Therefore, even if the power feed relay portion is arranged to correspond to the positioning hole, the temperature of the light source board is less likely to be increased. Accordingly, the heat dissipation property of the light source is effectively ensured and a space for the power feed relay portion is allocated on the light source board.

The present technology may include following configurations.

(1) The light source board may include an identification portion on the plate surface that is opposed to the heat dissipation member, and the identification portion includes identification information relating to the light source board. The identification portion may be arranged in the positioning hole. The identification portion of the light source board is arranged in the positioning hole that is through the heat dissipation member and the identification portion can be seen through the positioning hole. With such a configuration, even after the light source board is mounted on the heat dissipation member, the identification information of the light source board can be obtained and it is effective for component management. The identification information includes information regarding, for example, a specification (brightness, light flux, chromaticity, chromaticity rank) of the light source board or the light source, a manufacturing number (a manufacturing number, a manufacturing lot number) of the light source board or the light source, a manufactured time of the light source board or the light source (manufactured year, manufactured month, manufactured date), or a manufactured place of the light source board or the light source.

(2) The two sides constituting the corner portion of the hole edge portion of the positioning hole may be positioned on the two sides of the plate surface of the light source board. Accordingly, if the two sides constituting the corner portion of the plate surface of the light source board are not positioned on the respective two sides constituting the corner portion of the hole edge portion of the positioning hole in mounting the light source board on the heat dissipation member, it is recognized that the light source board is not correctly positioned with respect to the heat dissipation member. Therefore, the light source board is positioned with higher accuracy and the light use efficiency is further improved and unevenness in brightness is less likely to be caused.

(3) The hole edge portion of the positioning hole may have a square shape having four corner portions, and three sides constituting off-diagonal two corner portions among the four corner portions may be parallel to three sides constituting off-diagonal two corner portions of the plate surface of the light source board, respectively. With such a configuration, the light source board is mounted on the heat dissipation member so that the three sides constituting off-diagonal two corner portions of plate surface of the light source board are parallel to the respective three sides constituting off-diagonal two corner portions of the hole edge portion of the positioning hole. Accordingly, the light source board is attached to the heat dissipation member with being positioned more effectively with respect to the heat dissipation member along the plate surface of the light source board. Accordingly, a mounting error that may be caused between the light source board and the heat dissipation member can be made smaller and the light entrance efficiency is further improved and unevenness in brightness is less likely to be caused in the exit light exiting the light guide plate through the light exit surface.

(4) One of the three sides constituting the two corner portions of the hole edge portions of the positioning hole may be away from the light source board with a clearance. With such a configuration, the position of the light source board is confirmed according to the determination whether the clearance between at least one of the three sides constituting the two corner portions of the hole edge portion of the positioning hole and the light source board has a constant width over an entire length thereof. Therefore, the position of the light source board is confirmed by using the light passing through the clearance, for example. Accordingly, the light source board is positioned with higher accuracy.

(5) Two of the three sides constituting the two corner portions of the hole edge portion of the positioning hole may be opposed to each other. One of the two sides may be away from the light source board with the clearance, and another one of the two sides may be positioned on one of the three sides constituting the two corner portions of the plate surface of the light source board. With such a configuration, when the light source board is mounted on the heat dissipation member, the light source board is positioned with respect to the heat dissipation member with higher accuracy in the following manner. The light source board is positioned to keep the clearance between one of the two opposed sides among the three sides constituting the two corner portions of the hole edge portion of the positioning hole and the light source board to have a constant width over an entire length thereof. Further, the light source board is positioned such that the other side is positioned on one of the three sides constituting the two corner portions of the plate surface of the light source board.

(6) The plate surface of the light source board may have a rectangular shape and have a short-side direction that matches a thickness direction of the light guide plate and a long-side direction that matches a direction perpendicular to the thickness direction of the light guide plate. The light source may include light sources that are arranged on the light source board along the long-side direction and each of the light sources may not overlap the positioning hole. With such a configuration, since the light sources are arranged on the light source board so as not to overlap the positioning hole, heat from the light sources are released substantially evenly via the heat dissipation member. Accordingly, the thermal environment around the light sources is stable and the light emission efficiency of each light source is equalized and the unevenness in brightness is further less likely to be caused.

(7) The light source board may include light source boards that are arranged linearly along the long-side direction and mounted on the heat dissipation member. With this configuration, the light source boards are positioned with respect to the heat dissipation member by the positioning hole and the light source boards are positioned with respect to each other. Accordingly, difference in the amount of rays of light emitted from each of the light sources mounted on the light source boards and entering the light guide plate through the light entrance surface is less likely to be caused and unevenness in brightness is further less likely to be caused.

(8) The power feed relay portion may be arranged on the light source board to be opposed to an end portion of the light guide plate. With this configuration, since no light source is arranged on the portion of the light source board where the power feed relay portion is arranged, dark portions having a smaller amount of incident light may be caused on opposed portions of the light entrance surface of the light guide plate. However, since the power feed relay portion is arranged on the portion of the light source board opposed to the end portion of the light guide plate, dark portions are less likely to be caused in the most part of the middle portion of the light guide plate. Accordingly, the unevenness in brightness is further less likely to be caused.

(9) The lighting device may further include a casing member. The casing member may include a light guide plate support portion configured to support a plate surface of the light guide plate opposite from the light exit surface, and a heat dissipation member mount portion where the heat dissipation member is mounted. With such a configuration, the plate surface that is an opposite surface from the light exit surface of the light guide plate is supported by the light guide plate support portion of the casing member and the heat dissipation member where the light source board is mounted is mounted on the heat dissipation member mount portion of the casing member. Accordingly, the light guide plate and the light source are maintained in the optimal positions via the casing member.

(10) The hole edge portion of the positioning hole may include at least two positioning pieces that are parallel to the respective two sides constituting the corner portion thereof and the positioning pieces may contact the light source board. Accordingly, at least two positioning pieces that are provided on the hole edge portion of the positioning hole are in contact with the light source board so that the light source board is positioned easily and precisely. This improves workability and the LED board 118 is positioned with higher accuracy.

Next, to solve the above problems, a display device according to the present technology includes the above lighting device and a display panel displaying with using light from the lighting device.

Such a display device includes the lighting device supplying light to the display panel has improved light use efficiency and less occurrence of unevenness in brightness, and therefore, the display having excellent display quality is achieved.

The display panel may be a liquid crystal panel. The display device as a liquid crystal display device has a variety of applications, such as a television display or a personal-computer display. In particular, it is suitable for a large screen display.

### Advantageous Effect of the Invention

According to the technology disclosed herein, light usage efficiency is improved and unevenness in brightness is less likely to occur.

### BRIEF DESCRIPTION OF THE DRAWINGS

FIG. 1 is an exploded perspective view of a general configuration of a television device according to a first embodiment.

FIG. 2 is an exploded perspective view of a general configuration of a liquid crystal display device of the liquid crystal display device.

FIG. 3 is a plan view an arrangement configuration of a chassis, a light guide plate, an LED board, and a heat dissipation member in a backlight unit included in the liquid crystal display device.

FIG. 4 is a cross-sectional view taken along line iv-iv in FIG. 3.

FIG. 5 is a cross-sectional view taken along line v-v in FIG. 3.

FIG. 6 is a perspective view illustrating the heat dissipation member and the LED board before mounted to each other.

FIG. 7 is a front view illustrating the heat dissipation member to which the LED board is mounted.

FIG. 8 is a rear view illustrating the heat dissipation member to which the LED board is mounted.

FIG. 9 is a front view of the LED board.

FIG. 10 is a rear view of the LED board.

FIG. 11 is a front view of the heat dissipation member.

FIG. 12 is a front view illustrating the LED board that is positioned with respect to the heat dissipation member.

FIG. 13 is a perspective view illustrating a heat dissipation member and an LED board before mounted to each other according to a second embodiment.

FIG. 14 is a front view of the heat dissipation member.

FIG. 15 is a front view of the heat dissipation member to which the LED board is attached.

FIG. 16 is a front view illustrating a heat dissipation member to which an LED board is attached according to a third embodiment.

FIG. 17 is a front view illustrating a heat dissipation member to which an LED board is attached according to a fourth embodiment.

FIG. 18 is an exploded perspective view illustrating a heat dissipation member, an LED board, and a light guide plate according to a fifth embodiment.

FIG. 19 is a cross-sectional view illustrating a cross-sectional configuration of the heat dissipation member, the LED board, and the light guide plate.

FIG. 20 is an exploded perspective view illustrating a heat dissipation member and an LED board according to a sixth embodiment.

FIG. 21 is a plan view illustrating an arrangement configuration of a chassis, a heat dissipation member, an LED board and a light guide plate according to a seventh embodiment.

FIG. 22 is a front view of a heat dissipation member according to an eighth embodiment.

FIG. 23 is a front view of the heat dissipation member to which an LED board is attached.

FIG. 24 is a cross-sectional view illustrating a chassis and an LED board according to a ninth embodiment.

FIG. 25 is a cross-sectional view illustrating a positioning hole that is through a side plate of the chassis and the LED board.

### MODE FOR CARRYING OUT THE INVENTION

### First Embodiment

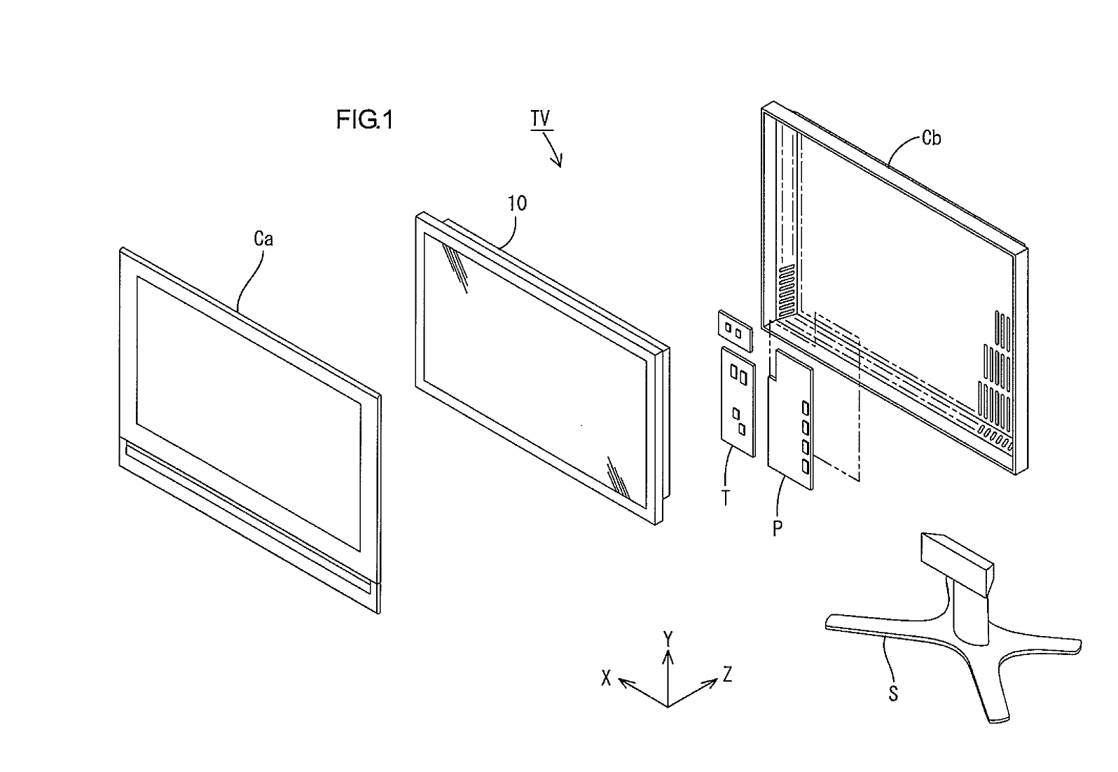

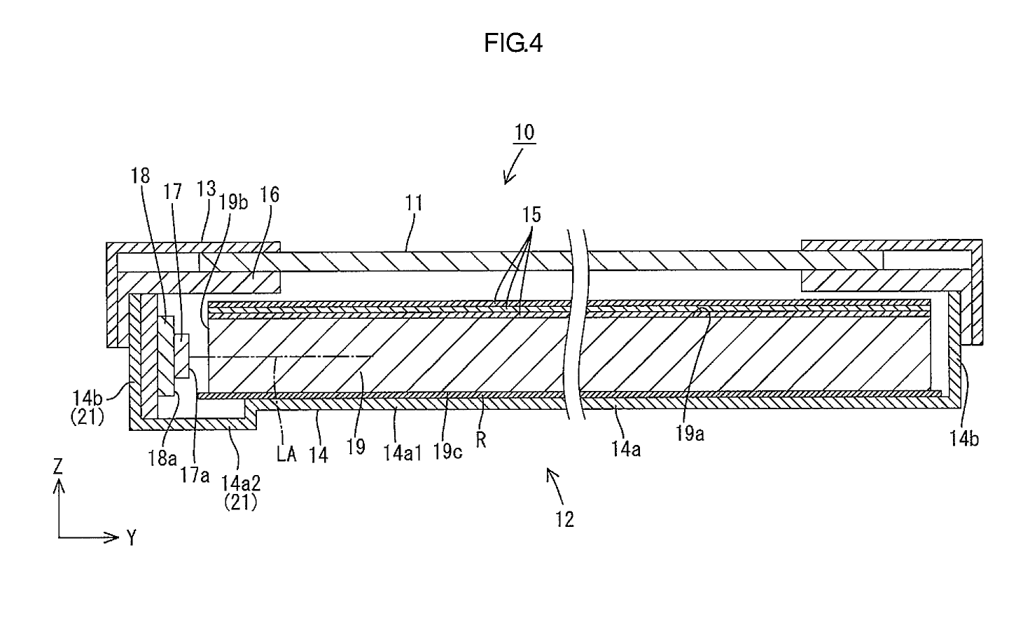

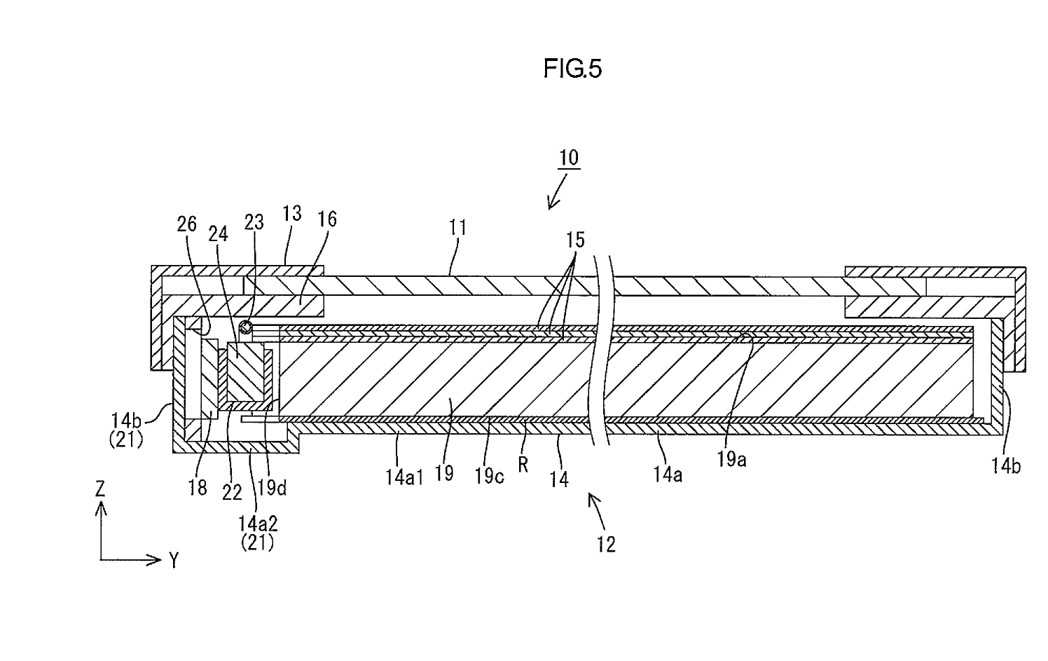

A first embodiment will be described with reference to FIGS. 1 to 12. According to this embodiment, a liquid crystal display device 10 will be described. X-axis, Y-axis and Z-axis are indicated in some drawings. The axes in each drawing correspond to the respective axes in other drawings. An upper side in FIGS. 4 and 5 corresponds to a front-surface side and a lower side in FIGS. 4 and 5 corresponds to a rear-surface side.

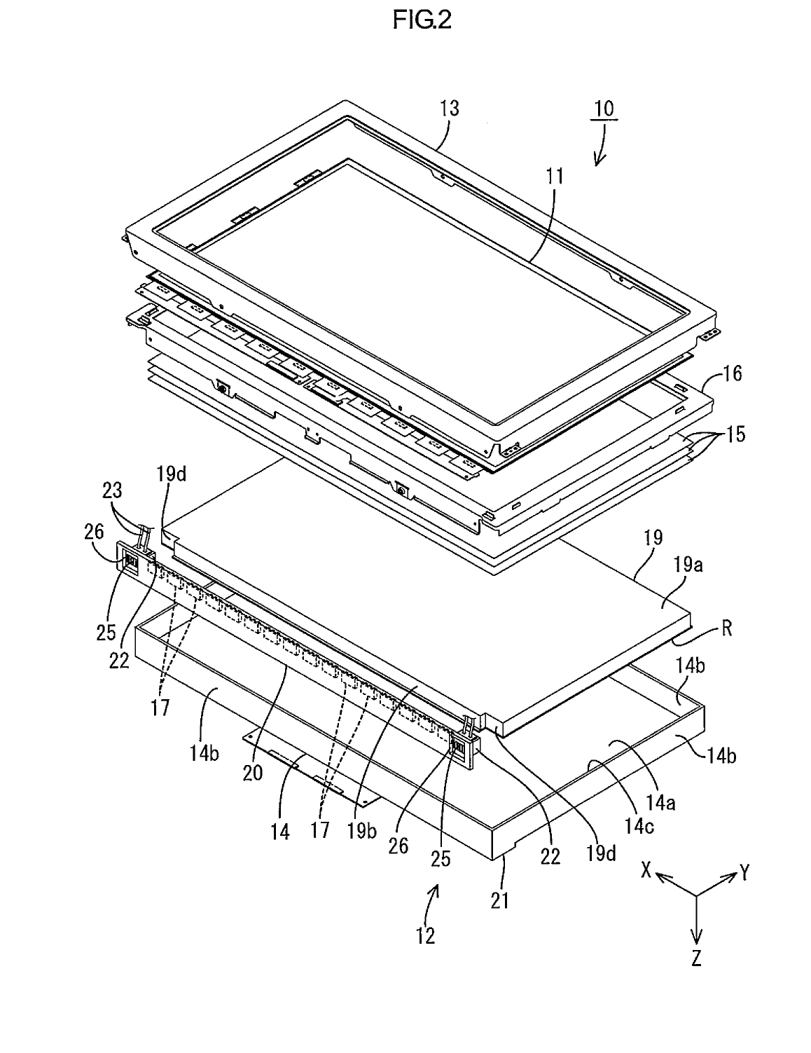

As illustrated in FIG. 1, a television device TV according to this embodiment includes the liquid crystal display device 10, front and rear cabinets Ca and Cb that hold the liquid crystal display device 10 therebetween, a power source P, a tuner T, and a stand S. An overall shape of the liquid crystal display device (a display device) 10 is landscape rectangular (longitudinal). The liquid crystal display device 10 is held in a vertical position. As illustrated in FIG. 2, the liquid crystal display device 10 includes a liquid crystal panel 11 as a display panel and a backlight unit (a lighting device) 12 as an external light source. The liquid crystal panel 11 and the backlight unit 12 are held with a bezel 13 having a frame-like shape.

As illustrated in FIG. 2, the liquid crystal panel has a landscape rectangular shape (rectangular and longitudinal) in a plan view and includes a pair of glass substrates and liquid crystals. The substrates having high light transmissivity are bonded together with a predetermined clearance therebetween. The liquid crystals are sealed between the substrates. On one of the substrates (an array substrate), switching components (e.g., TFTs), pixel electrodes, and an alignment film are arranged. The switching components are connected to source lines and gate lines that are perpendicular to each other. The pixel electrodes are connected to the switching components. On the other substrate (a CF substrate), a color filter, common electrodes, and an alignment film are arranged. The color filter has color sections such as R (red), G (green) and B (blue) color sections that are arranged in a predetermined pattern. The liquid crystal panel 11 includes a display area and a non-display area. The display area is an inner area of a screen in which images are displayed. The non-display area is an outer area of the screen around the display area and has a frame-like shape. Polarizing plates are arranged on outer sides of the substrates.

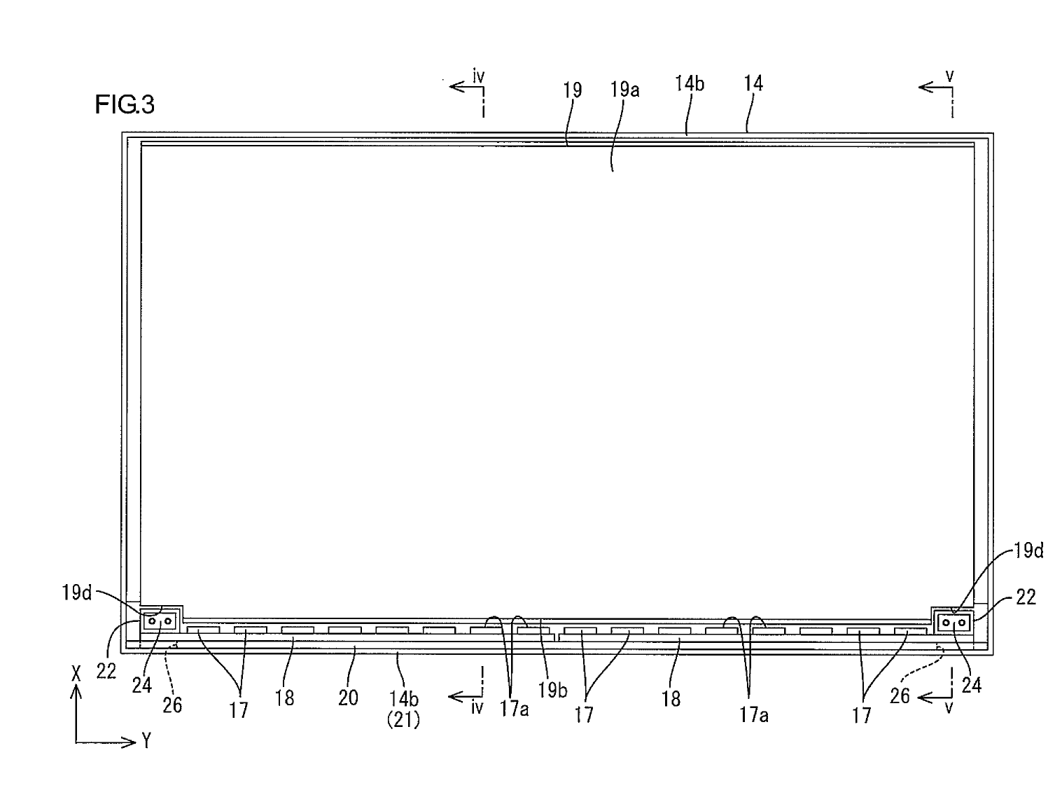

Next, the backlight unit 12 will be described in detail. As illustrated in FIG. 2, the backlight unit 12 includes a chassis (a casing member) 14, optical members 15, and a frame (a holding member) 16. The chassis 14 having a substantially tray-like shape includes a light exit portion 14c that opens to the front side (a liquid crystal panel 11 side). The optical members 15 cover the light exit portion 14c of the chassis 14. The frame 16 holds down a light guide plate 19, which will be described later, from the front side. LEDs (Light Emitting Diodes) 17 provided as light sources, an LED board (light source board) 18 on which the LEDs 17 are mounted, a heat dissipation member 20 to which the LED board 18 is attached, and a light guide plate 19 are arranged in the chassis 14. The light guide plate 19 is configured to guide light from the LEDs 17 and directs the light toward the optical members 15 (the liquid crystal panel 11, the light exit side). The LED board 18 is arranged at one of long-side end portions (on a front side in FIG. 2 or a left side in FIG. 3) of the backlight unit 12, and accordingly, the LEDs 17 mounted on the LED board 18 are located locally close to one of long-side end portions of the liquid crystal panel 11. The backlight unit 12 according to this embodiment is so-called a single-edge-light type (or a side-light type) backlight. Hereinafter, components of the backlight unit 12 will be described in detail.

The chassis 14 is made of a metal plate having good heat conductivity such as an aluminum plate and an electrolytic zinc-coated steel sheet (SECC). As illustrated in FIGS. 2 to 4, the chassis 14 includes a bottom plate 14a having a landscape rectangular shape similar to the liquid crystal panel 11 and side plates 14b extending from an outer end of each side (a pair of long sides and a pair of short sides) of the bottom plate 14a. A long-side direction and a short-side direction of the chassis 14 (the bottom plate 14a) correspond to the X-axis direction (the horizontal direction) and the Y-axis direction (the vertical direction), respectively. Most part of the bottom plate 14a is a light guide plate support portion 14a1 that supports the light guide plate 19 from a rear-surface side (an opposite side from the light exit surface 19a side). An end part of the bottom plate 14a on the LED board 18 side is a step portion 14a2 that projects to the rear-surface side to form a step. The step portion 14a2 and the side plate (a heat dissipation member mount portion) 14b that is continuously provided from an end of the step portion 14a2 constitute an LED container 21 where the LEDs 17, the LED board 18, and the heat dissipation member 20 are arranged. The bezel 13 is fixed to the side plate 14b with screws having the frame 16 in between.

As illustrated in FIG. 2, similar to the liquid crystal panel 11 and the chassis 14, the optical members 15 have a landscape rectangular shape in a plan view. The optical members 15 are placed on a front surface (a light exit side surface) of the light guide plate 19 and located between the liquid crystal panel 11 and the light guide plate 19. Light receives predetermined optical effects while passing through the optical members 15 and exits toward the liquid crystal panel 11. The optical members 15 include multiple sheet-like members (three sheets in this embodiment) which are overlaid with each other. Each optical member 15 may be selected from a diffuser sheet, a lens sheet, and a reflecting type polarizing sheet, whatever is appropriate.

As illustrated in FIGS. 2 and 4, the frame 16 has a frame shape extending along outer edge portions of the light guide plate 19 and holds down substantially the entire edge portions of the light guide plate 19 from the front side. The frame 16 is made of synthetic resin. A front surface of the frame 16 may be in black so as to have light blocking properties. The frame 16 receives outer edge portions of the liquid crystal panel 11 from the rear-surface side.

As illustrated in FIGS. 2 and 4, each of the LEDs 17 includes an LED chip that is arranged on a board fixed on the LED board 18 and sealed with resin. The LED chip mounted on the board has one main light emission wavelength. Specifically, the LED chip that emits light in a single color of blue is used. The resin that reals the LED chip contains phosphors dispersed therein. The phosphors emit light in a predetermined color when excited by blue light emitted from the LED chip. Overall color of light emitted from the LED 17 is white. The phosphors may be selected, as appropriate, from yellow phosphors that emit yellow light, green phosphors that emit green light, and red phosphors that emit red light. The phosphors may be used in combination of the above phosphors. The LED 17 includes a main light-emitting surface 17a that is opposite from a mount surface of the LED 17 on which the LED board 18 is mounted. Namely, the LED 17 is a top-surface-emitting type LED. Each LED includes the light-emitting surface 17a having a landscape rectangular front view shape and an optical axis LA (a direction in which light having highest light emission intensity is directed) at substantially a center thereof. The optical axis LA is represented by a dashed-dotted line in FIG. 4.

As illustrated in FIGS. 2 to 4, the LED board 18 has an elongated plate-like shape extending in the long-side direction (the X-axis direction) of the chassis 14 and the light guide plate 19. The LED board 18 is arranged in the LED container 21 of the chassis 14 such that plate surfaces of the LED board 18 are parallel to the X-Z plane, i.e., perpendicular to plate surfaces of the liquid crystal panel 11 and the light guide plate 19 (the optical members 15). Namely, the long-side direction and the short-side direction of the LED board 18 correspond to the X-axis direction (a direction that is perpendicular to a plate thickness direction of the light guide plate 19 and parallel to the light entrance surface 19b) and the Z-axis direction (a plate thickness direction of the light guide plate 19), respectively. The LED board 18 is arranged such that a plate surface thereof (a mount surface 18a) facing the inner side is opposed to one of the long side end surfaces (the light entrance surface 19b) of the light guide plate 19 to have a certain clearance therebetween in the Y-axis direction. Therefore, the direction in which the LEDs 17, the LED board 18, and the light guide plate 19 are arranged substantially matches the Y-axis direction. The LED board 18 has a length dimension that is approximately a half of the long-side dimension of the light guide plate 19. Two LED boards 18 are arranged to correspond to a heat dissipation member 20, which will be described later. Namely, the two LED boards 18 are arranged linearly such that the long side direction of each LED board 18 matches each other (FIG. 3).

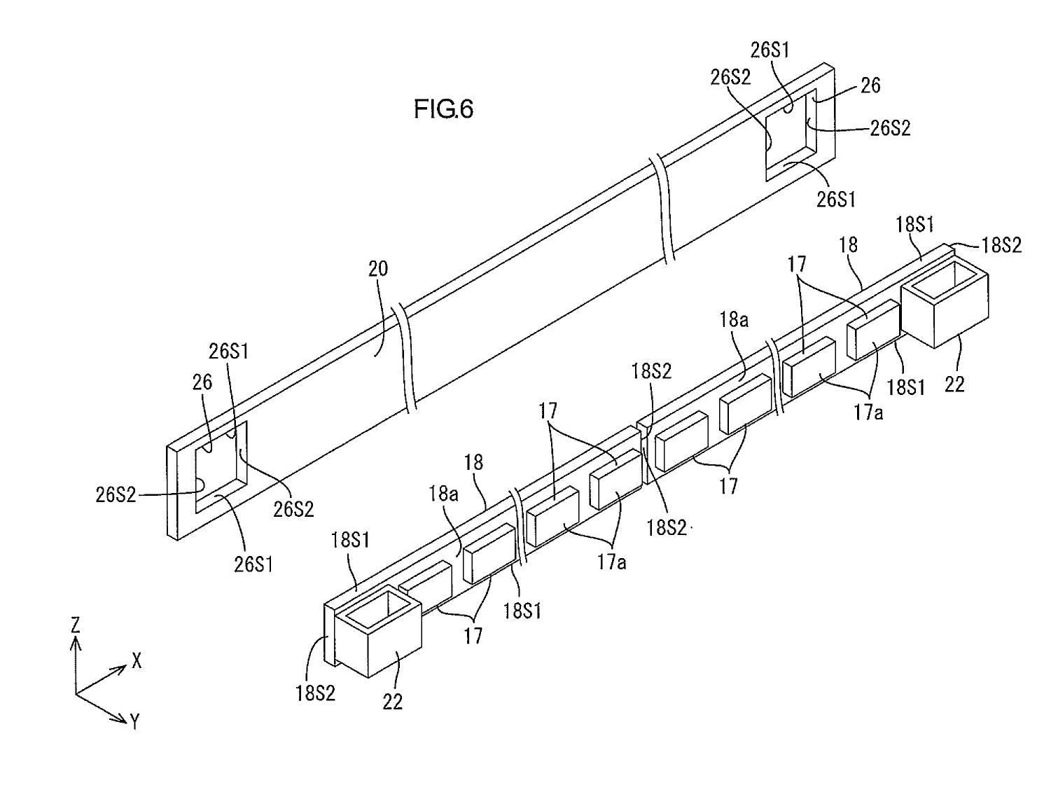

As illustrated in FIGS. 6, 9, and 10, the plate surface of the LED board 18 is a landscape rectangular front or rear view shape. The plate surface of the LED board 18 includes a pair of first sides 18S1 and a pair of second sides 18S2. The first sides 18S1 constitute long sides parallel to the X-axis direction (the long-side direction of the light entrance surface 19b) and the second sides 18S2 constitute short sides parallel to the Z-axis direction (the short-side direction of the light entrance surface 19b). Each of four corner portions of the plate surface of the LED board 18 is formed by the respective first sides 18S1 and the respective second sides 18S2 that cross each other to forma right angle.

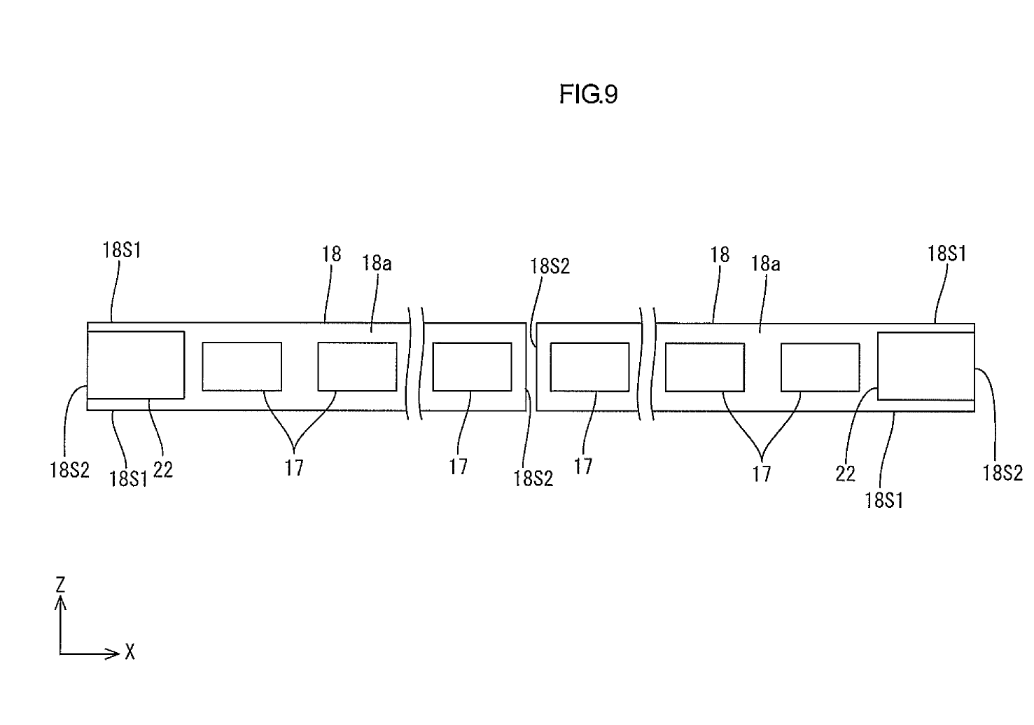

As illustrated in FIGS. 6 and 9, the LED board 18 includes a mount surface 18a on which the LEDs 17 are surface-mounted. The mount surface 18a is one of the plate surfaces that faces an inner side, namely, a surface of the LED board 18 that faces the light guide plate 19 (a surface opposite the light guide plate 19). The LEDs 17 are arranged apart from each other in a line (i.e., linearly) on the mount surface 18a of the LED board 18 along the long-side direction of the LED board 18 (the X-axis direction). In other words, multiple LEDs 17 are arranged at intervals in each of the long-side end portions of the backlight unit 12 along the long-side direction. A metal-film trace (not illustrated), such as a copper-foil trace, is formed on the mount surface 18a of each LED board 18. The metal-film trace extends in the X-axis direction and crosses over a group of the LEDs 17 so as to connect the adjacent LEDs 17 in series. Further, a board-side connector (a power feed relay portion) 22 that relays power feed to the LEDs 17 is mounted at an end portion of the trace on the mount surface of the LED board 18. The LEDs 17 and the board-side connector 22 are mounted on only one plate surface of the LED board 18 and such an LED board 18 is an LED board of a one-side mounting type. The board-side connector 22 is arranged on one of two end portions of the length dimension of the LED board 18, that is, a portion of the LED board 18 adjacent to an end portion of the long-side dimension of each of the chassis 14 and the light guide plate 19. Therefore, each of the board-side connectors 22 that are arranged on the respective two LED boards 18 is arranged adjacent to each of the LED board 18 side two corners of the chassis 14 and the light guide plate 19. The two board-side connectors 22 are arranged to be opposed to two end portions of the long-side dimension of the light guide plate 19. The board-side connector 22 is a low-heat-generating member that causes a relatively small amount of heat generation according to current applying compared to the LED 17. The LED 17 is a high-heat-generating member that causes a relatively treat amount of heat generation according to current applying. A substrate of the LED board 18 is made of metal similar to the chassis 14 and the trace (not illustrated), which is described before, is formed on the surface of the substrate having an insulation layer therebetween. An insulating material such as ceramics may be used as the material for the substrate of the LED board 18.

A line-side connector 24 is arranged at an end of a relay line (a line member) 23 that is connected to an external LED drive circuit, which is not illustrated. As illustrated in FIG. 5, the line-side connector 24 is fitted to the board-side connector 22 from the front side along the Z-axis direction (a plate thickness direction of the light guide plate 19) and connected to the board-side connector 22. The board-side connector 22 has a recessed shape and the line-side connector 24 has a convex shape. The board-side connector 22 and the line-side connector 24 are fitted to each other to establish electric connection. Accordingly, the driving power is supplied from the external LED drive circuit to each LED 17 on the LED board 18.

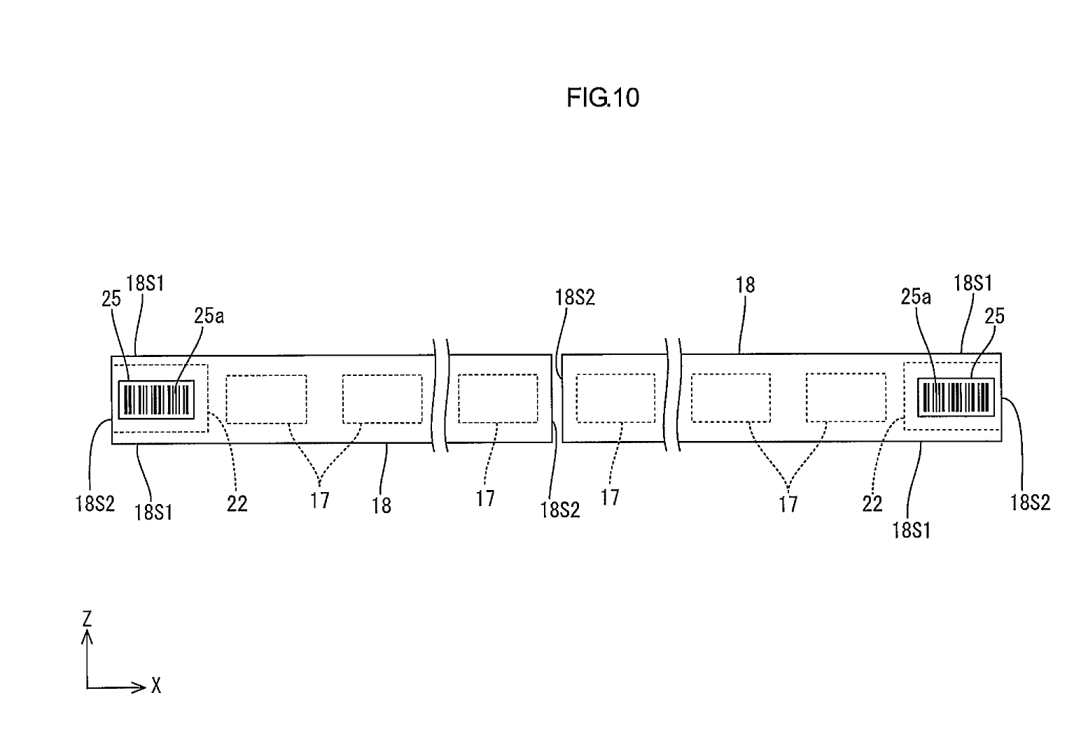

As illustrated in FIG. 10, an identification portion 25 including identification information of each LED board 18 is provided on an outer side surface of the LED board 18, that is, a plate surface (a surface opposed to a heat dissipation member 20) facing an opposite side from the light guide plate 19 side (a heat dissipation member 20 side). The identification portion 25 includes a film-shaped base member and a bar code 25a printed thereon and the identification portion 25 is bonded to a plate surface of the LED board 18 with an adhesive that is coated over a bonding surface of the base member that faces the LED board 18. The bar code 25a includes identification information of each LED board 18. The identification information includes information relating to, for example, a specification (brightness, light flux, chromaticity, chromaticity rank) of each LED board 18 or each LED 17, a manufacturing number (a manufacturing number, a manufacturing lot number) of each LED board 18 or each LED 17, a manufactured time of each LED board 18 or each LED 17 (manufactured year, manufactured month, manufactured date), or a manufactured place of each LED board 18 or each LED 17. The identification portion 25 is provided on one of two end portions of the length dimension of the LED board 18, that is, provided adjacent to an end portion of the long-side dimension of each of the chassis 14 and the light guide plate 19. Therefore, the two identification portions 25 provided on the respective two LED boards 18 are arranged adjacent to two LED-board 18-side corners of the chassis 14 and the light guide plate 19. Each identification portion 25 is arranged to overlap each board-side connector 22 seen from the front side or the rear side. In other words, the identification portion 25 is arranged to hold the LED board 18 with the board-side connector 22 from two sides with respect to a plate thickness direction.

The light guide plate 19 is made of substantially transparent (high transmissivity) synthetic resin (e.g. acrylic resin or polycarbonate such as PMMA) that has a refractive index sufficiently higher than that of the air. As illustrated in FIGS. 2 and 3, the light guide plate 19 has a landscape rectangular shape in a plan view similar to the liquid crystal panel 11 and the bottom plate 14a of the chassis 14. A main surface of the light guide plate 19 faces and is parallel to each plate surface of the liquid crystal panel 11 and the optical member 15. A long-side direction and a short-side direction of the main surface of the light guide plate 19 correspond to the X-axis direction and the Y-axis direction, respectively. A thickness direction of the light guide plate 19 that is perpendicular to the main surface of the light guide plate 19 corresponds to the Z-axis direction. As illustrated in FIG. 4, the light guide plate 19 is arranged on a rear-surface side of the liquid crystal panel 11 the optical member 15 within the chassis 14. One of long-side end surfaces of the outer peripheral surface of the light guide plate 19 (a lower side surface in FIG. 3, a left side surface in FIG. 4) is opposed to the LED board 18 that is arranged in one long-side end portion of the chassis 14 and the LEDs 17 mounted thereon. Therefore, a direction in which the LEDs 17 (the LED board 18) and the light guide plate 19 are arranged matches the Y-axis direction (the vertical direction) and a direction in which the optical member 15 (the liquid crystal panel 11) and the light guide plate 19 are arranged matches the Z-axis direction, and the directions are perpendicular to each other. The light guide plate 19 is configured to guide the light, which is emitted from the LEDs 17 and directed along the Y-axis direction and enters the light guide plate 19 through the long-side end surface, toward the optical member 15 (the front side, the light exit side) and exits the light guide plate 19 through the main surface.

As illustrated in FIG. 4, the light guide plate 19 has plate surfaces one of which faces the front side (a surface opposite the liquid crystal panel 11 and the optical member 15) and is a light exit surface 19a. Light exits the light guide plate 19 through the light exit surface 19a toward the optical member 15 and the liquid crystal panel 11. The light guide plate 19 includes outer peripheral end surfaces that are adjacent to the plate surfaces of the light guide plate 19 and the outer peripheral end surfaces include two long-side end surfaces thereof each extend in the X-axis direction (the direction in which the LEDs 17 are arranged, the long-side direction of the LED board 18). One of the long-side end surfaces on a left side in FIG. 4 (on a lower side in FIG. 3) is opposite the LEDs 17 (the LED boards 18) with a predetermined space therebetween and serves as a light entrance surface 19b through which light from the LEDs 17 enters the light guide plate 19. The light entrance surface 19b is parallel to the main surface of the LED board 18 (the X-Z plane) and substantially perpendicular to the light exit surface 19a. The light guide plate 19 includes recesses 19d at respective end portions of the length dimension of the light entrance surface 19b (in the X-axis direction). The board-side connector 22 on each LED board 18 that is opposed to the light entrance surface 19b is fitted to the recess 19d. An arrangement direction in which the LEDs 17 and the light entrance surface 19b are arranged matches the Y-axis direction and parallel to the light exit surface 19a.

As illustrated in FIG. 4, a reflection sheet R is arranged on one of the plate surfaces of the light guide plate 19, that is, a plate surface 19c opposite to the light exit surface 19a so as to cover an entire area of the plate surface. Light that travels within the light guide plate 19 is reflected by the reflection sheet R to be directed toward the front side. The reflection sheet R is arranged between a light guide plate support portion 14a1 of the bottom plate 14a included in the chassis 14 and the light guide plate 19. The light guide plate 19 is supported by the light guide plate support portion 14a1 of the chassis from the rear-surface side with the reflection sheet R therebetween. The reflection sheet R is arranged such that an end thereof on a side of the light entrance surface 19b of the light guide plate protrudes outwardly than the light entrance surface 19b, that is, closer to the LEDs 17 and light that travels from the LEDs 17 is reflected by the protruded portion. Accordingly, light entrance efficiency of light entering the light guide plate 19 through the light entrance surface 19b is improved. A scattering portion (not illustrated) is patterned on one of the light exit surface 19a and the opposite plate surface 19c of the light guide plate 19 or a surface of the reflection sheet R so as to have a predetermined plane distribution. The scattering portion scatters light within the light guide plate 19. Accordingly, the light exiting the light guide plate 19 through the light exit surface 19a has an even distribution within a plane.

As illustrated in FIGS. 3 and 6, similar to the LED board 18, the heat dissipation member 20 has a rectangular plate-like shape extending along the long-side direction (the X-axis direction) of the chassis 14 and the light guide plate 19. The heat dissipation member 20 is arranged in the LED container 21 included in the chassis 14 such that a plate surface thereof is parallel to the plate surface of the LED board 18. A long-side direction, a short-side direction, and a thickness direction of the heat dissipation member 20 correspond to the X-axis direction (a direction that is perpendicular to the plate thickness direction of the light guide plate 19 and parallel to the light entrance surface 19b), the Z-axis direction (the plate thickness direction of the light guide plate 19), and the Y-axis direction (the direction in which the LEDs 17 and the light guide plate 19 are arranged), respectively. The thickness direction is perpendicular to the plate surface of the heat dissipation member 20. The heat dissipation member 20 has a length dimension (a long-side dimension) that is substantially equal to the long-side dimension of the light guide plate 19 and is approximately twice as the length dimension of the LED board 18. The heat dissipation member 20 has a width dimension (a short-side dimension) that is greater than the width dimension of the LED board 18 and is substantially equal to a height dimension of the side plate 14b included in the LED container 21.

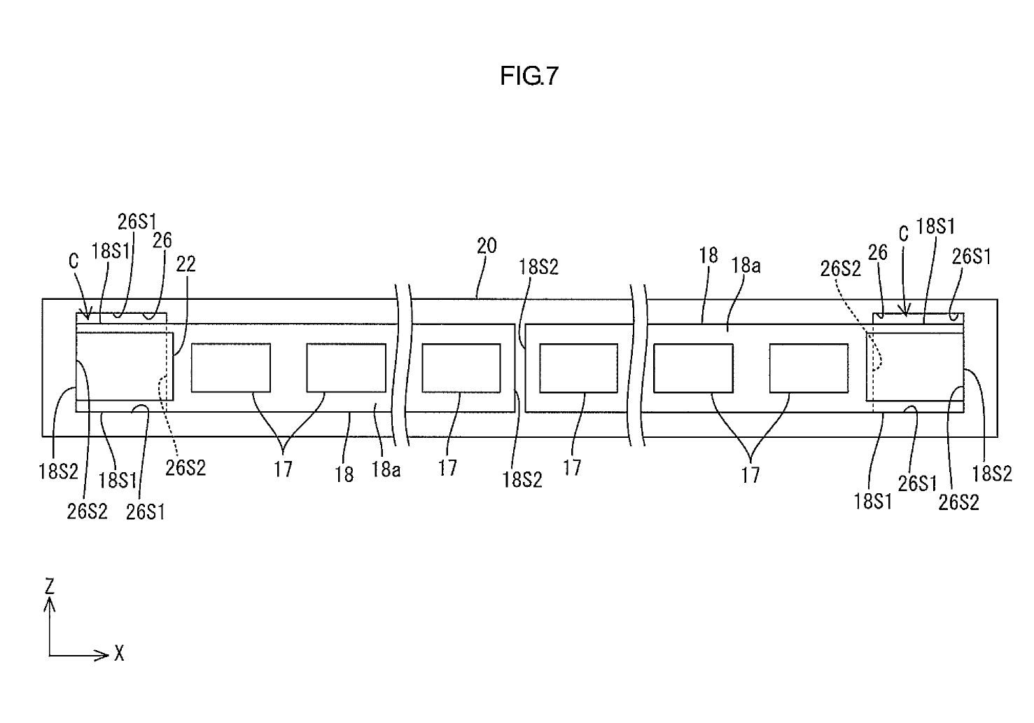

As illustrated in FIGS. 3 and 7, two LED boards 18 are arranged linearly in the X-axis direction on the plate surface of the heat dissipation member 20 facing an inner side (the light guide plate 19 side). The plate surface of the heat dissipation member 20 facing an outer side (the opposite side from the light guide plate 19 side) is attached to the side plate 14b included in the LED container 21 of the chassis 14. Namely, the heat dissipation member 20 is sandwiched between the LED boards 18 and the side plate 14b of the LED container 21 and in contact with both of them. The heat dissipation member 20 is made of metal having high thermal conductivity, such as aluminum. If heat generated by the LEDs 17 according to the current applying is transferred to the heat dissipation member 20 via the LED board 18, the heat dissipation member 20 dissipates the heat from a surface thereof and transfers the heat to the side plate 14b of the chassis so that the heat from the LEDs 17 is effectively released. Accordingly, high light emission efficiency of the LEDs 17 is maintained and the LED 17 has a long life-span. The heat dissipation member 20 is closely fixed to the side plate 14b of the chassis 14 with mounting means such as an adhesive, a double-sided tape, or screws.

According to the present embodiment, as illustrated in FIGS. 6, 7, and 11, the heat dissipation member 20 has positioning through holes 26 with which the LED board 18 is positioned with respect to the plate surface direction thereof. The heat dissipation member 20 has two positioning holes 26 at respective two end portions of the length dimension thereof (the X-axis direction). Namely, the number of the positioning holes 26 is same as the number of the LED boards 18 and each of the LED boards 18 is positioned independently from each other. Each of the positioning holes 26 is located to correspond to a part of each LED board 18 seen from a front side or a rear side. When mounting the LED board 18 on the heat dissipation member 20, an operator recognizes the mounting position of each LED board 18 based on positional relation between the sides 18S1, 18S2 of each LED board 18.

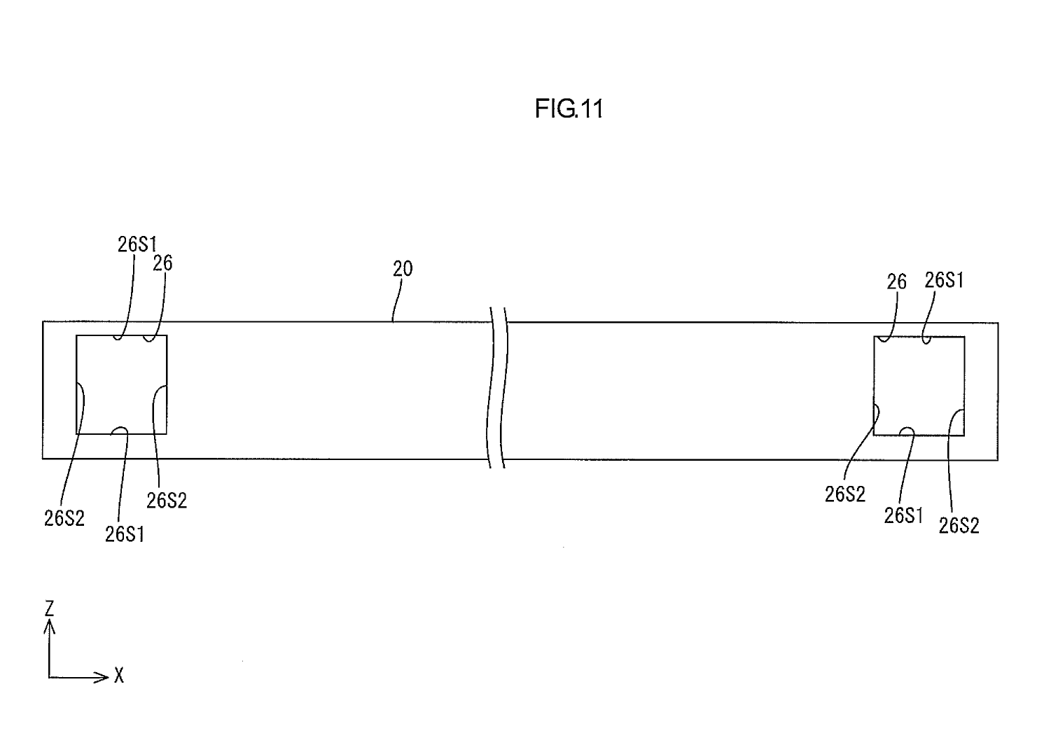

Specifically, as illustrated in FIGS. 3, 6, and 7, the heat dissipation member 20 has the positioning holes 26 in the two end portions of the length dimension thereof, that is, in the portions opposed to the respective two end portions of the length dimension of the light guide plate 19. Each of the positioning holes 26 overlaps the end portion of each LED board 18 with a front view or a side view. As illustrated in FIGS. 7 and 11, the positioning hole 26 has a substantially quadrate shape with a front view or a rear view and has four corner portions. The heat dissipation member 20 has a hole edge portion around the positioning hole 26 and the hole edge portion includes a pair of first sides 26s1 that are parallel to the X-axis direction (the long-side direction of the heat dissipation member 20 and the LED board 18) and a pair of second sides 26S2 that are parallel to the Z-axis direction (the short-side direction of the heat dissipation member 20 and the LED board 18). Each of the four corner portions included in the hole edge portion of the positioning hole 26 is formed by the first side 26S1 and the second side 26S2 crossing each other and forms a substantially right angle. Therefore, the first sides 26S1 of the hole edge portion of the positioning hole 26 are parallel to the respective first sides 18S1 of the LED board 18 and the second sides 26S2 of the hole edge portion are parallel to the respective second sides 18S2 of the LED board 18.

As illustrated in FIG. 7, when the LED board 18 is attached to the heat dissipation member 20, the LED board 18 is correctly positioned in a correct position with respect to the heat dissipation member 20 in the Z-axis direction so that a rear-surface side one of the first sides 26S1 of the hole edge portion of the positioning hole 26 is positioned on and overlaps a rear-surface side one of the first sides 18S1 of the LED board 18 (so that light does not leak from a clearance between the first sides 18S1, 26S1 on the rear-surface side). Accordingly, the optical axis LA of light from each LED 17 corresponds to a middle position of the light guide plate 19 with respect to the plate thickness direction. Therefore, light entrance efficiency of light emitted from each LED 17 and entering the light guide plate 19b through the light entrance surface 19b becomes optimal. On the other hand, when the LED board 18 is attached to the heat dissipation member 20, the LED board 18 is correctly positioned in a correct position with respect to the heat dissipation member 20 in the X-axis direction so that one of the second sides 26S2 of the hole edge portion of the positioning hole 26 closer to an end of the heat dissipation member 20 is positioned on and overlaps one of the second sides 1852 closer to an end of the heat dissipation member 20 (on an end opposite to the adjacent LED board 18 side) (so that light does not leak from a clearance between the second sides 18S2, 26S2). With the above configuration, the LEDs 17 that are arranged on end portions of the respective LED boards 18 and in a middle portion of the light guide plate 19 (the LEDs 17 that are mounted on different LED boards 18 and adjacent to each other) are arranged with a distance therebetween and the distance is substantially equal to each interval between other LEDs 17. Accordingly, the amount of the light exiting the middle portion of the long-side dimension of the light guide plate 19 is less likely to be excessive or too small compared to the amount of the light exiting other portions of the light guide plate 19. Further, with the above configuration, on each of the LED boards 18, the board-side connector 22 and the LED 17 that is adjacent to the board-side connector 22 are positioned with respect to the end portions of the light guide plate 19 in the X-axis direction. Therefore, brightness unevenness is less likely to be caused in the end portions of the long-side dimension of the light guide plate 19.

As illustrated in FIG. 7, the length of each of the sides 26S2 of the hole edge portion of the positioning hole 26 is slightly greater than a width dimension of the LED board 18 and the length of each of the sides 26S1 is slightly smaller than a long-side dimension of the board-side connector 21. With such a configuration, when the rear-surface side first side 18S1 of the LED board 18 is positioned on and overlaps the rear-surface side first side 26S1 of the hole edge portion of the positioning hole 26, the front-surface side first side 26S1 of the hole edge portion and the front-surface side first side 18S1 of the LED board 18 are parallel to each other and have a certain clearance C therebetween. The clearance C constitutes a slit having a constant width over its entire length if the LED board 18 is positioned correctly without being tilted with respect to the positioning hole 26. Therefore, an operator can recognize the mount position of the LED board 18 with high accuracy based on the light passing through the clearance C. As described before, an end portion of the plate surface of the LED board 18 has three sides 18S1, 18S2 that form two corner portions that are off-diagonal, and the hole edge portion of the positioning hole 26 has three sides 26S1, 26S2 that form two corner portions that are off-diagonal and adjacent to the end of the heat dissipation member 20. Based on the positional relation between the three sides 18S1, 18S2 and the three sides 26S1, 26S2, the operator can easily see whether the mounting position of the LED board 18 with respect to the light entrance surface 20 is optimal.

As illustrated in FIG. 7, the positioning hole 26 with the above configuration is provided to overlap the board-side connector 22 over its entire area with a front view or a rear view. The board-side connector 22 is provided on one end portion of the length dimension of the LED board 18. Therefore, all of the LEDs 17 mounted on the LED board 18 do not overlap the positioning hole 26 with a front view or a rear view. In other words, the board-side connector 22 overlaps the positioning hole 26 with respect to the X-axis direction and all the LEDs 17 are offset from the positioning hole 26 and do not overlap the positioning hole 26 with respect to the X-axis direction. The heat dissipation member 20 has the positioning hole 26 therethrough and a heat dissipation property is likely to be deteriorated locally in the portion having the positioning hole 26. If the LED is arranged to overlap the positioning hole 26, heat from the overlapped LED is less likely to be dissipated. This may reduce the heat dissipation efficiency of the whole LED board. Further, difference in temperature of the overlapped LED and temperature of other non-overlapped LEDs is caused and this may cause difference in the chromaticity of the emission light and the emission light amount. With the above configuration including the positioning holes 26, heat from each LED 17 is effectively dissipated. More in detail, heat generated form each LED 17 according to current applying is transferred evenly to the heat dissipation member 20 via the LED board 18. The LED board 18 effectively dissipates the heat as a whole and difference in temperatures of the LEDs 17 is less likely to be caused. Accordingly, the chromaticity of light emitted from each LED 17 and the amount of light emitted from each LED 17 are averaged and brightness unevenness or color unevenness is less likely to be caused. The board-side connector 22 is a low-heat-generating member that causes a relatively small amount of heat generation compared to the LED 17. Therefore, even if the board-side connector 22 is arranged to overlap the positioning hole 26, a temperature of the LED board 18 is less likely to be increased.

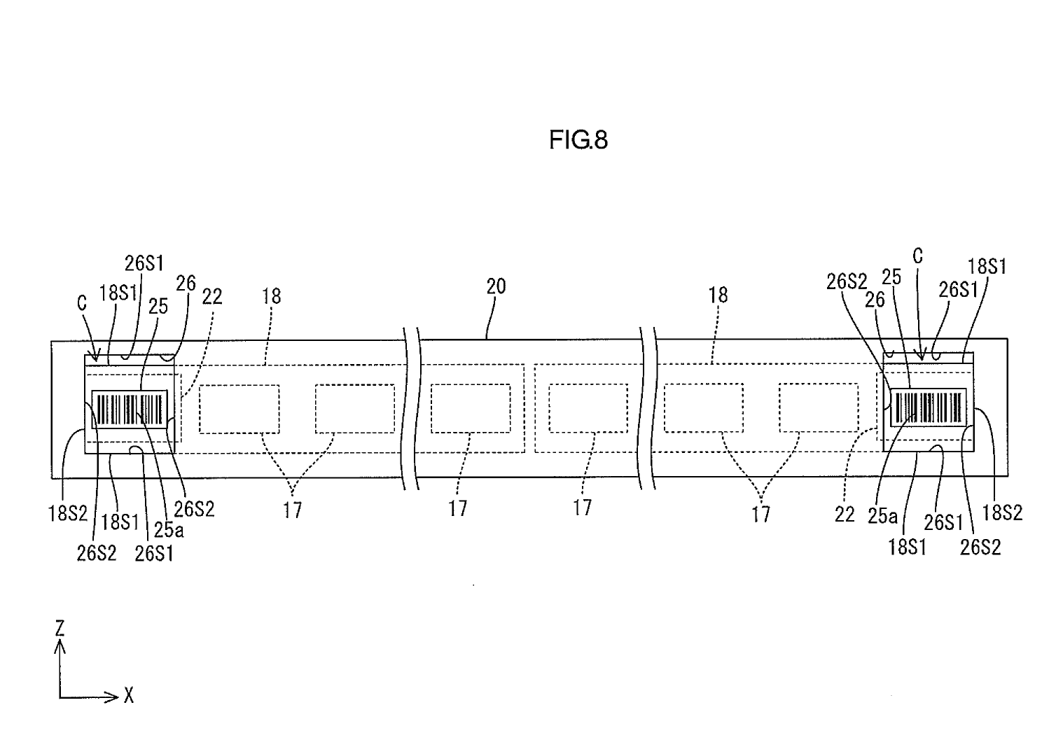

As illustrated in FIG. 8, the identification portion 25 provided on the plate surface of the LED board 18 facing the outer side is located in the positioning hole 26 and surrounded by the sides 26S1, 26S2 of the hole edge portion. Therefore, when the heat dissipation member 20 with the LED board 18 attached thereto is seen from the rear side, the bar code 25a printed on the identification portion 25 can be seen through the positioning hole 26. Accordingly, the LED board 18 where the heat dissipation member 20 is attached is effective for easy management.

The configuration is described and operations will be described next. If the power of the liquid crystal display device 10 with the above configuration is turned on, driving of the liquid crystal panel 11 is controlled by a control circuit, which is not illustrated, and driving power is supplied from an LED drive circuit, which is not illustrated, to each of the LEDs 17 on the LED board 18 to control the driving. The light emitted from each LED 17 is guided by the light guide plate 19 to be irradiated to the liquid crystal panel 11 via the optical member 15, and thus a certain image is displayed on the liquid crystal panel 11. Hereinafter, operations of the backlight device 12 will be described in detail.

If each LED 17 is lit on, the light emitted from each LED 17 enters the light guide plate 19 through the light entrance surface 19b, as illustrated in FIG. 4. A certain space is provided between the LEDs 17 and the light entrance surface 19b and the space is covered with an extended portion of the reflection sheet R from the rear-surface side. Therefore, the light emitted from the LED 17 reflects off the extended portion to be directed toward the light entrance surface 19b. Accordingly, the light entrance efficiency of light entering the light guide plate 19 through the light entrance surface 19b is improved. The light entering the light guide plate 19 through the light entrance surface 19b is fully reflected at a boundary face between the light guide plate 19 and an external air layer or reflected by the reflection sheet R and travels within the light guide plate 19 and is reflected with scattered by a scattering portion. Accordingly, the light has the angles of incidence with respect to the light exit surface 19a which do not exceed the critical angle and the exiting of light from the light guide plate 19 through the light exit surface 19a is accelerated.

The light entrance efficiency of light emitted from the LED 17 and entering the light guide plate 19 through the light entrance surface 19b and the brightness distribution of light exiting the light guide plate 19 through the light exit surface 19a vary according to the positional relation between the light entrance surface 19b of the light guide plate 19 and the LEDs 17. Specifically, if the optical axis LA of light from the LED 17 matches a middle position of the plate-thickness dimension of the light guide plate 19 (in the Z-axis direction), the light from the LED 17 enters the light guide plate 19 through the light entrance surface 19b most effectively (the light entrance efficiency is maximized). If the optical axis does not match the middle position and is positioned closer to the front-surface side or the rear-surface side with respect to the Z-axis direction, the light entrance efficiency is likely to be lowered as the offset amount becomes greater. Especially, as the plate thickness of the light guide plate 19 becomes smaller, the variation amount of the light entrance efficiency with respect to the offset amount is increased and high positional accuracy is likely to be required. On the other hand, among the LEDs 17 that are arranged on each LED board 18, if the two LEDs 17 that are arranged on the respective end portions of each LED board 18 are located to have a substantially equal distance from the respective two end portions of the long-side dimension of the light entrance surface 19b, the emission light is even within a plane of the light exit surface 19a of the light guide plate 19. If the two LEDs 17 are located with different distances from the respective two end portions of the light entrance surface 19b, the amount of exit light from the light guide plate 19 through one of the two end portions of the long-side dimension of the light exit surface 19a may be excessive or too small and this may cause unevenness in the exit light. Further, if the distance with respect to the X-axis direction between the adjacent LEDs 17 that are mounted on the respective different LED boards 18 is substantially equal to each interval between other LEDs 17, exit light becomes even within a plane of the light exit surface of the light guide plate 19. If the distance is different from the interval, the amount of exit light from the light guide plate 19 through the middle portion of the long-side dimension of the light exit surface 19a may be excessive or too small and this may cause unevenness in the exit light.

According to the present embodiment, when the LED board 18 is attached to the heat dissipation member 20 in the manufacturing process, the LED board 18 is attached in a correct position with reference to the positioning hole 26 that is through the heat dissipation member 20. Therefore, a mounting error that may be caused between the LED board 18 and the heat dissipation member 20 is possibly decreased. Accordingly, the positional error that may be caused between the light entrance surface 19b and the LEDs 17 in a direction along the light entrance surface 19b of the light guide plate 19 is less likely to be caused. This improves light entrance efficiency of light emitted from LED 17 and entering the light guide plate 19 through the light entrance surface 19b and brightness unevenness is less likely to be caused in the exit light exiting the light guide plate 19 through the light exit surface 19a.

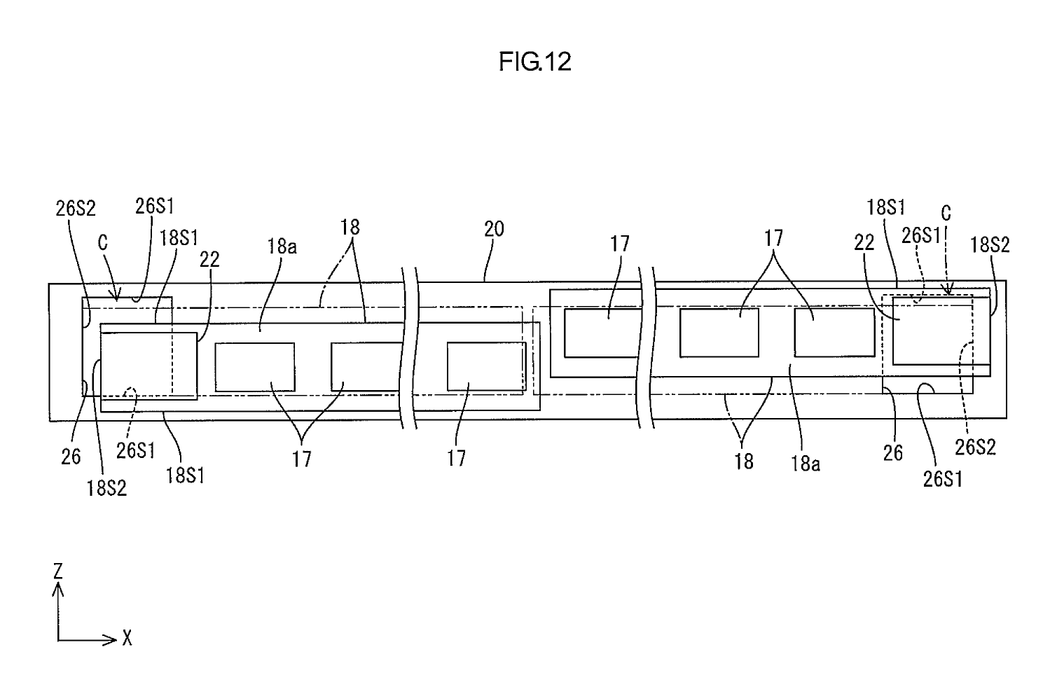

In the mounting operation, when a plate surface of the LED board 18 facing an outer side is attached to a plate surface of the heat dissipation member 20 facing an inner side, the LED board 18 is positioned with respect to the positioning hole 26 as follows. As illustrated in FIG. 6, the end portion of the plate surface of the LED board 18 has three sides 18S1, 18S2 that form two corner portions that are off-diagonal, and the hole edge portion of the positioning hole 26 has three sides 26S1, 26S2 that form two corner portions that are off-diagonal and adjacent to the end of the heat dissipation member 20. The three sides 18S1, 18S2 are parallel to the respective three sides 26S1, 26S2. More specifically, for example, if the position of the LED board 18 is shifted diagonally downward right with respect to the positioning hole 26, as illustrated in the left portion in FIG. 12, the LED board 18 is moved diagonally upward left so that the rear-surface side first side 18S1 of the plate surface of the LED board 18 is positioned on and overlaps the rear-surface side first side 26S1 of the hole edge portion of the positioning hole 26 and the left-side second side 18S2 of the plate surface of the LED board 18 is positioned on and overlaps the left-side second side 26S2 of the hole edge portion of the positioning hole 26. If a slight positional error is caused when the sides 18S1, 18S2 are positioned on the sides 26S1, 26S2, respectively, light leaks through the positioning hole 26. Therefore, the positional error is easily found. Accordingly, the sides 18S1, 18S2 and the sides 26S1, 26S2 are positioned with respect to each other with high positioning accuracy. Further, it is confirmed whether the clearance C between the front-surface side first side 18S1 of the plate surface of the LED board 18 and the front-surface side first side 18S1 of the hole edge portion of the positioning hole 26 has a constant width over an entire length thereof. If the width of the clearance C is not constant, it is easily recognized that the width of the clearance C is not constant based on the light leaking through the clearance C and the positioning accuracy is improved. Accordingly, as illustrated by a dashed two-dotted line in FIG. 12, the LED board 18 is positioned in the correct position with respect to the heat dissipation member 20 with high accuracy. If the LED board 18 is shifted diagonally upward right with respect to the positioning hole 26 as illustrated in the right portion in FIG. 12, the LED board 18 is moved diagonally downward left in FIG. 12 so that the side 18S1 is positioned on and overlaps the side 26S1 and the side 18S2 is positioned on and overlaps the side 26S2. Accordingly, the LED board 18 is positioned in the correct position with respect to the heat dissipation member 26.

The LED board 18 is positioned with respect to the heat dissipation member 20, as described above. Accordingly, the optical axis LA of light from the LED 17 corresponds to the middle position of the plate thickness dimension of the light entrance surface 19b (in the Z-axis direction), as illustrated in FIG. 4. Further, as illustrated in FIG. 3, the LEDs 17 are arranged in the X-axis direction, and two LEDs 17 that are arranged at two ends are spaced from the respective two end portions of the long-side dimension of the light entrance surface 19b with a substantially equal distance. Further, the distance between the adjacent LEDs 17 each of which is mounted on a different LED board 18 is substantially equal to the interval between other LEDs 17. Accordingly, the light entrance efficiency of light emitted from each LED 17 and entering the light guide plate 19 through the light entrance surface 19 is maximized and unevenness in brightness is less likely to be caused in the exit light within a surface plane of the light exit surface 19a. Therefore, display quality of images displayed on the liquid crystal panel 11 is improved. Further, the two LED boards 18 are positioned independently from each other by the corresponding positioning hole 26. Therefore, a positional error is less likely to be caused between the adjacent LED boards 18 with respect to the X-axis direction and the Z-axis direction.

If each LED 17 is lit on to use the liquid crystal display device 10, heat is generated from each LED 17. The heat generated from each LED 17 is transferred to the heat dissipation member 20 via the LED board 18. The heat dissipation member 20 dissipates the heat therefrom and transfers the heat to the side plate 14b to effectively release the heat. The heat dissipation member 20 has the positioning hole 26 therethrough and a heat dissipation property is likely to be deteriorated locally in the portion having the positioning hole 26. The LED board 18 is attached to the heat dissipation member 20 so that the board-side connector 22 overlaps the positioning hole 26 and all the LEDs 17 do not overlap the positioning hole 26. Therefore, the heat from each LED 17 is effectively released by the heat dissipation member 20 even with the positioning holes 26. Further, since all the LEDs 17 do not overlap the positioning hole 26, difference in temperatures of the LEDS is less likely to be caused and the chromaticity of the emission light and the emission light amount from each LED 17 are maintained to be even. Accordingly, brightness unevenness or color unevenness is less likely to be caused in the exit light exiting from the light guide plate 19 through the light exit surface 19a. This further improves display quality of images displayed on the liquid crystal panel 11.

As is described before, according to the present embodiment, the backlight device (the lighting device) 12 includes the LED (light source) 17, the light guide plate 19, the LED board (light source board) 18, the board-side connector (power feed relay portion) 22, and the heat dissipation member 20. The light guide plate 19 includes the light entrance surface 19b on an end surface thereof and includes the light exit surface 19a on a plate surface thereof. The light entrance surface 19b is opposed to the LEDs 17 and light from the LEDs 17 enters the light guide plate 19 via the light entrance surface 19b. The light exits the light guide plate 19 through the light exit surface 19a. The LEDs 17 are arranged on the LED board 18 and the LED board 18 has a square plate surface that is opposed to the light entrance surface 19b. The board-side connector 22 is mounted on the LED board 18 and relays power feed to the LEDs 17. The LED boards 18a are amounted on the heat dissipation member 20 and the heat dissipation member 20 dissipates the heat from the LEDs 17. The heat dissipation member 20 has the positioning holes 26 that are through the heat dissipation member 20 and with which the LED board 18 is positioned with respect to the heat dissipation member 20. The hole edge portion around the positioning hole 26 has at least one corner portion that is formed by the two sides 26S1, 26S2. The heat dissipation member 20 is arranged so that the sides 26S1, 26S2 are parallel to the respective two sides 18S1, 18S2 that form one corner portion of the plate surface of the LED board 18 and so that the positioning hole 26 corresponds to the board-side connector 22.

With such a configuration, the LED 17 mounted on the LED board 18 emits light with the power feed relayed by the board-side connector 22. The light emitted from the LED 17 enters the light guide plate 19 through the light entrance surface 19b that faces the LED 17 and travels within the light guide plate 19 and exits the light guide plate 19 through the light exit surface 19a. The LED 17 generates heat according to the light emission. However, the heat from the LED 17 is transmitted to the heat dissipation member 20 via the LED board 18 to be released.

The LED board 18 is attached to the heat dissipation member 20 so that the two sides 18S1, 18S2 that form one corner portion of the plate surface of the LED board 18 are parallel to the respective two sides 26S1, 26S2 that form one corner portion of the hole edge portion of the positioning hole 26. Thus, the LED board 18 is attached to the heat dissipation member 20 so as to be positioned optimally with respect to the heat dissipation member 20 in a direction along the plate surface of the LED board 18. Accordingly, a mounting error that may be caused between the LED board 18 and the heat dissipation member 20 is decreased and a positional error that may be caused between the light entrance surface 19b and the LEDs 17 with respect to a direction along the light entrance surface 19b of the light guide plate 19 is decreased. Therefore, the light entrance efficiency of light emitted from the LED 17 and entering the light guide plate 19 through the light entrance surface 19b is improved and brightness unevenness is less likely to be caused in the exit light exiting the light guide plate 19 through the light exit surface 19a. Further, the positioning hole 26 is through the heat dissipation member 20. Therefore, when the LED board 18 is attached to the heat dissipation member 20, the positional relation between the two sides 26S1, 26S2 that form the corner portion of the hole edge portion of the positioning hole 26 and the two sides 18S1, 18S2 that form the corner portion of the plate surface of the LED board 18 can be easily recognized according to light passing through the positioning hole 26. Accordingly, the LED board 18 is positioned with high accuracy.

As described before, the heat dissipation member 20 has the positioning hole 26 being therethrough, and the heat dissipation property is deteriorated locally in the portion of the heat dissipation member 20 where the positioning hole is formed. On the LED board 18 that is attached to the heat dissipation member 20, the board-side connector 22 is arranged on a portion of the LED board 18 corresponding to the positioning hole 26. Therefore, the LEDs 17 are arranged not to overlap the positioning hole 26 and the heat generated from the LEDs 17 can be released effectively via the heat dissipation member 20 even having the positioning holes 26. The board-side connector 22 causes a relatively small amount of heat generation compared to the LED 17. Therefore, even if the board-side connector 22 is arranged to correspond to the positioning hole 26, the temperature of the LED board 18 is less likely to be increased. Accordingly, the heat dissipation property of the LED 17 is effectively ensured and a space for the board-side connector 22 is allocated on the LED board 18.

The LED board 18 has the identification portion 25 including identification information of each LED board 18 on the plate surface thereof facing the heat dissipation member 20 side. The identification portion 25 is arranged in the positioning hole 26. The identification portion 25 of the LED board 18 is arranged in the positioning hole 26 that is through the heat dissipation member 20 and the identification portion 25 can be seen through the positioning hole 26. With such a configuration, even after the LED board 18 is attached to the heat dissipation member 20, the identification information of the LED board 18 can be obtained and it is effective for component management. The identification information includes information regarding, for example, a specification (brightness, light flux, chromaticity, chromaticity rank) of each LED board 18 or each LED 17, a manufacturing number (a manufacturing number, a manufacturing lot number) of each LED board 18 or each LED 17, a manufactured time of each LED board 18 or each LED 17 (manufactured year, manufactured month, manufactured date), or a manufactured place of each LED board 18 or each LED 17.

The two sides 26S1, 26S2 that form the corner portion of the hole edge portion of the positioning hole 26 are positioned on and overlap the respective two sides 18S1, 18S2 that form the corner portion of the plate surface of the LED board 18. Accordingly, if the two sides 18S1, 18S2 that form the corner portion of the plate surface of the LED board 18 are not positioned on the respective two sides 26S1, 26S2 that form the corner portion of the hole edge portion of the positioning hole 26 in attaching the LED board 18 to the heat dissipation member 20, it is recognized that the LED board 18 is not correctly positioned with respect to the heat dissipation member 20. Therefore, the LED board 18 is positioned with higher accuracy and the light use efficiency is further improved and unevenness in brightness is less likely to be caused.

The hole edge portion of the positioning hole 26 has a square shape having four corner portions. The positioning hole 26 has three sides 26S1, 26S2 forming off-diagonal two corner portions and the LED board 18 has three sides 18S1, 18S2 forming off-diagonal two corner portions, and the three sides 18S1, 18S2 are parallel to the respective three sides 26S1, 26S2. Thus, the LED board 18 is attached to the heat dissipation member 20 so that the three sides 18S1, 18S2 forming off-diagonal two corner portions of plate surface of the LED board 18 are parallel to the respective three sides 26S1, 26S2 forming off-diagonal two corner portions of the hole edge portion of the positioning hole 26. Accordingly, the LED board 18 is attached to the heat dissipation member 20 with being positioned more effectively with respect to the heat dissipation member 20 along the plate surface of the LED board 18. Accordingly, a mounting error that may be caused between the LED board 18 and the heat dissipation member 20 can be made smaller and the light entrance efficiency is further improved and unevenness in brightness is less likely to be caused in the exit light exiting the light guide plate 19 through the light exit surface 19a.

The positioning hole 26 is formed to have the clearance C between at least one side 26S1 of the three sides 26S1, 26S2 that form the two corner portions of the hole edge portion and the LED board 18. With such a configuration, the position of the LED board 18 is confirmed according to the determination whether the clearance C between at least one side 26S1 of the three sides 26S1, 26S2 that form the two corner portions of the hole edge portion of the positioning hole 26 and the LED board 18 has a constant width over an entire length thereof. Therefore, the position of the LED board 18 is confirmed by using the light passing through the clearance, for example. Accordingly, the LED board 18 is positioned with higher accuracy.

The positioning hole 26 is formed to have the clearance C between the LED board 18 and one side 26S1 of the opposed two sides 26S1 among the three sides 26S1, 26S2 that form the two corner portions of the hole edge portion. Further, the other side 26S1 is positioned on and overlaps the one side 18S1 of the three sides 18S1, 18S2 that form the two corner portions of the plate surface of the LED board 18. With such a configuration, when the LED board 18 is attached to the heat dissipation member 20, the LED board 18 is positioned with respect to the heat dissipation member 20 with higher accuracy in the following manner. The LED board 18 is positioned to keep the clearance C between one side 26S1 of the two opposed sides 26S1 among the three sides 26S1, 26S2 that form the two corner portions of the hole edge portion of the positioning hole 26 and the LED board 18 to have a constant width over an entire length thereof. Further, the LED board 18 is positioned such that the other side 26S1 is positioned on and overlaps one side 18S1 among the three sides 18S1, 18S2 that form the two corner portions of the plate surface of the LED board 18.

The LED board 18 has a rectangular plate surface and the short-side direction thereof matches the plate thickness direction of the light guide plate 19 and the long-side direction thereof is orthogonal to the plate thickness direction of the light guide plate 19. The LEDs 17 are arranged on the LED board 18 along the long-side direction so as not to overlap the positioning holes 26. With such a configuration, since the LEDs 17 are arranged on the LED board 18 so as not to overlap the positioning holes 26, heat from the LEDs 17 are released substantially evenly via the heat dissipation member 20. Accordingly, the thermal environment around the LEDs 17 is stable and the light emission efficiency of each LED 17 is equalized and the unevenness in brightness is further less likely to be caused.

The LED boards 18 are attached to the heat dissipation member 20 so as to be linearly arranged along the long-side direction. With this configuration, the LED boards 18 are positioned with respect to the heat dissipation member 20 by the positioning holes 26 and the LED boards 18 are positioned with respect to each other. Accordingly, difference in the amount of rays of light emitted from each of the LEDs 17 mounted on the LED boards 18 and entering the light guide plate 19 through the light entrance surface 19b is less likely to be caused and unevenness in brightness is further less likely to be caused.

The board-side connector 22 is arranged on a portion of the LED board 18 opposed to each end portion of the light guide plate 10. With this configuration, since no LED 17 is arranged on the portions of the LED boards 18 where the board-side connectors 22 are arranged, dark portions having a smaller amount of incident light may be caused on opposed portions of the light entrance surface 19b of the light guide plate 19. However, since the board-side connectors 22 are arranged on the respective portions of the LED boards 18 opposed to the end portions of the light guide plate 19, dark portions are less likely to be caused in the most part of the middle portion of the light guide plate 19. Accordingly, the unevenness in brightness is further less likely to be caused.

The chassis (a casing member) 14 includes the light guide plate support portion 14a1 and the side plate (dissipation member mount portion) 14b. The light guide plate support portion 14a1 supports the plate surface 19c that is an opposite surface from the light exit surface 19a of the light guide plate 19. The heat dissipation member 20 is attached to the sideplate 14b. With such a configuration, the plate surface 19c that is an opposite surface from the light exit surface 19a of the light guide plate 19 is supported by the light guide plate support portion 14a1 of the chassis 14 and the heat dissipation member 20 where the LED boards 18 are attached is mounted on the side plate 14b of the chassis 14. Accordingly, the light guide plate 19 and the LEDs 17 are maintained in the optimal positions via the chassis 14.

### Second Embodiment

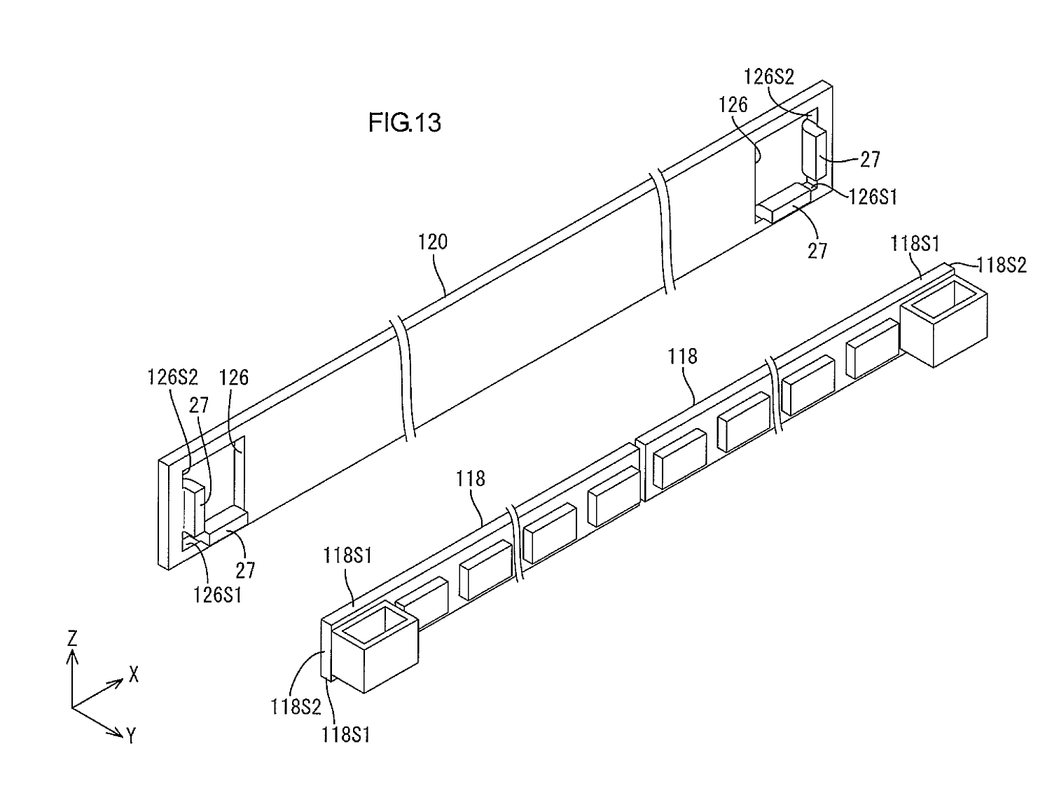

A second embodiment will be described with reference to FIGS. 13 to 15. In the second embodiment, a positioning piece 27 is provided on the hole edge portion of a positioning hole 126 in a heat dissipation member 120. The constructions, functions, and effects similar to those of the first embodiment will not be described.

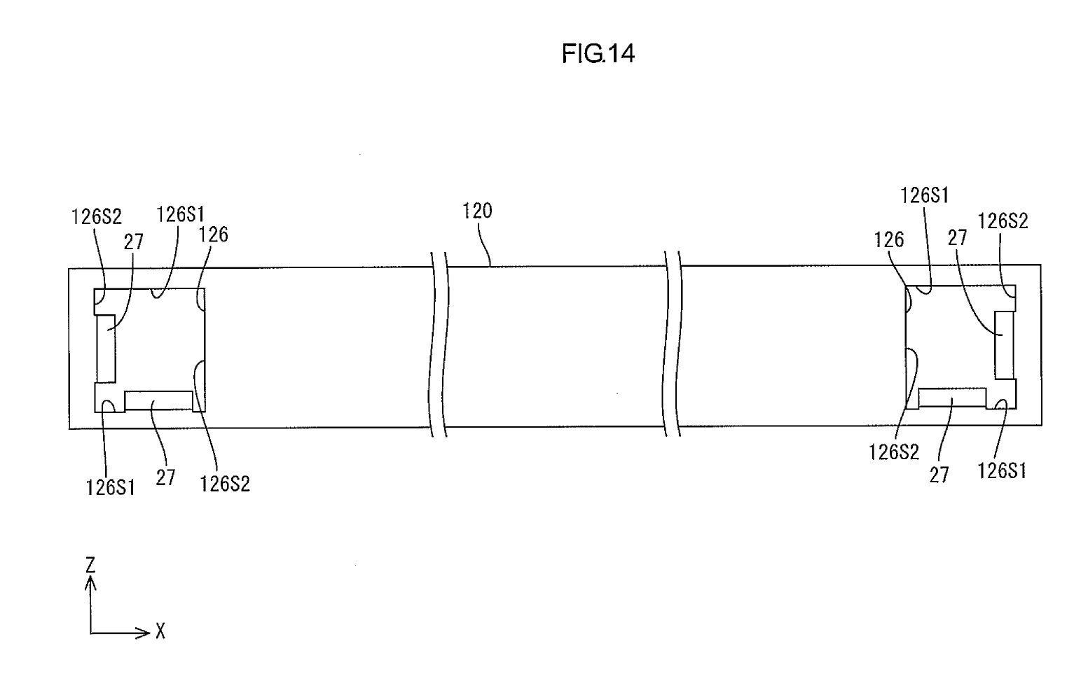

According to the present embodiment, as illustrated in FIGS. 13 and 14, the heat dissipation member 120 integrally includes the positioning piece 27 at a hole edge portion of the positioning hole 126. The positioning piece 27 is directly in contact with a LED board 118 to position the LED board 118. The positioning piece 27 is provided on each of a first side 126S1 and a second side 126s2 that form a corner portion of the hole edge portion of the positioning hole 126 and a total of two positioning pieces 27 are provided. Specifically, one of the two positioning pieces 27 projects and is curved from the rear-surface side first side 126S1 of the hole edge portion of the positioning hole 126 toward a LED board 118. An inner surface of the positioning piece 27 facing inside of the positioning hole 126 is parallel to the first side 126S1 (the X-axis direction). The other one of the positioning pieces 27 projects and is curved from the second side 126S2 of the hole edge portion of the positioning hole 126 toward the LED board 118. The second side 126S2 is located on a side closer to the heat dissipation member 120. An inner surface of the other positioning piece 27 facing the inside of the positioning hole 126 is parallel to the second side 126S2 (the Z-axis direction).

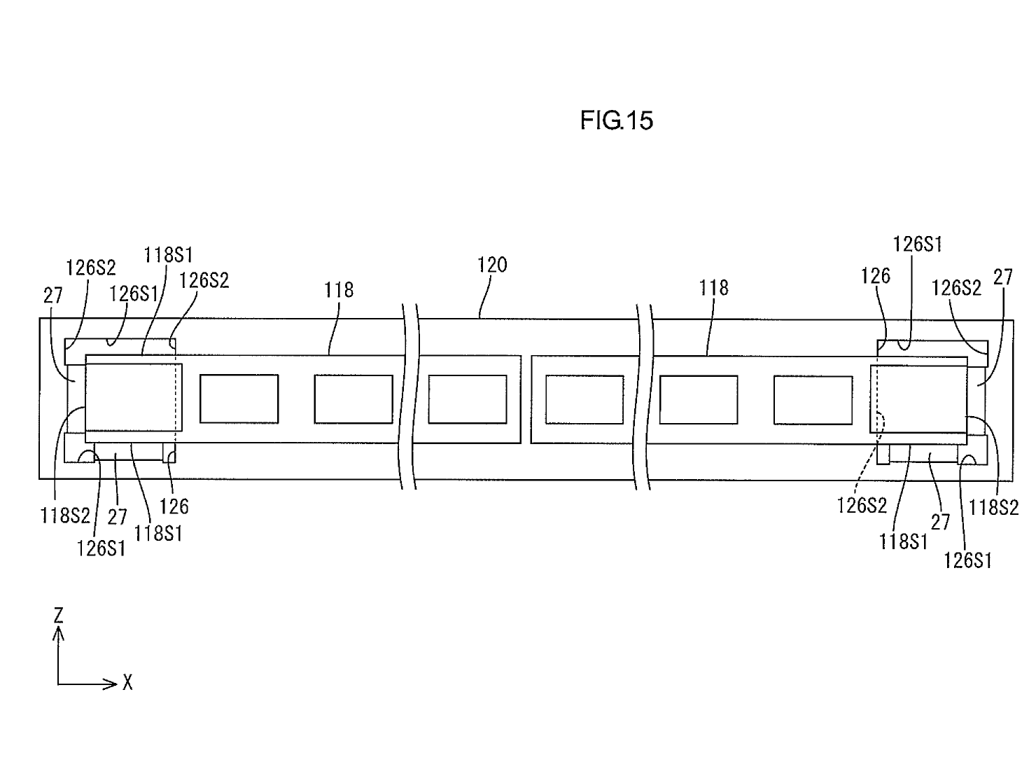

As illustrated in FIG. 15, when the LED board 118 is attached to the heat dissipation member 120, the positioning-hole 126 side second side 118S2 of the plate surface of the LED board 118 is set to be in contact with the inner surface of the one positioning piece 27 and the rear-surface side first side 118S1 of the plate surface of the LED board 118 is set to be in contact with the inner surface of the other positioning piece 27. Accordingly, each first side 118S1 and each second side 118S2 of the plate surface of the LED board 118 are parallel to each first side 126S1 and each second side 126S2 of the hole edge portion of the positioning hole 126, respectively. Further, the LED board 118 is positioned with respect to the heat dissipation member 120 along the plate surface thereof with high accuracy.

As described before, according to the present embodiment, at least two positioning pieces 27 are provided on the hole edge portion of the positioning hole 126 so as to be parallel to the two sides 126S1, 12652 that form the corner portion, respectively. The positioning pieces 27 are in contact with the LED board 118. Accordingly, at least two positioning pieces 27 that are provided on the hole edge portion of the positioning hole 126 are in contact with the LED board 118 so that the LED board 118 is positioned easily and precisely. This improves workability and the LED board 118 is positioned with higher accuracy.

### Third Embodiment

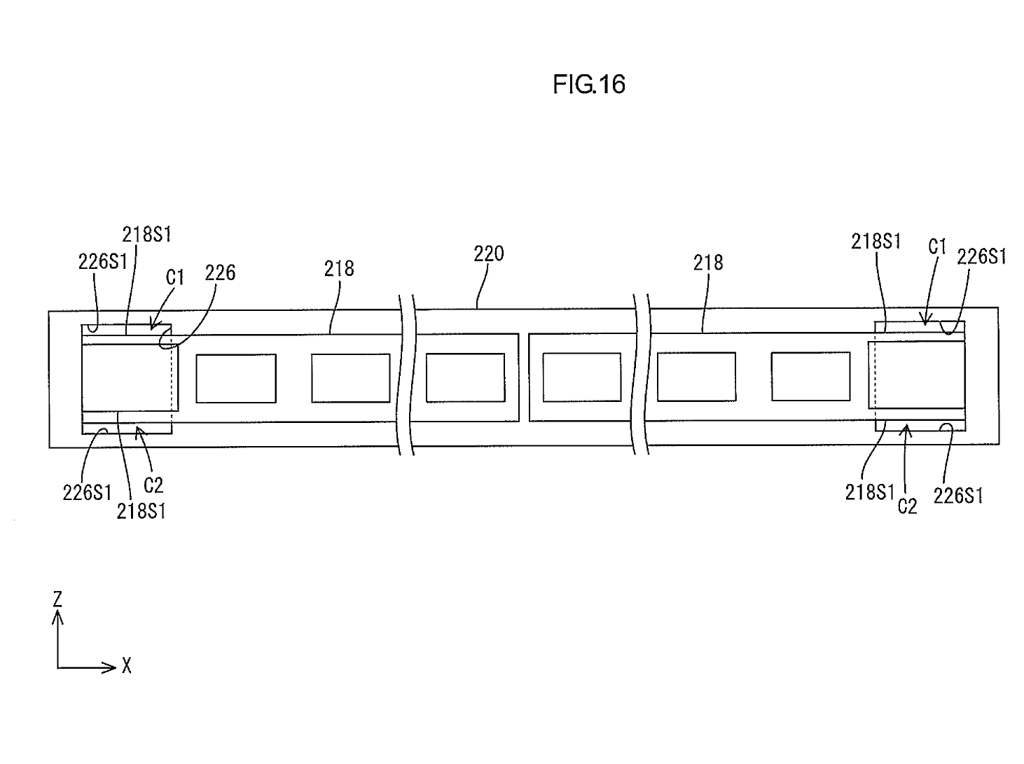

A third embodiment will be described with reference to FIG. 16. In the third embodiment, two clearances C1, C2 are provided between a positioning hole 226 and a LED board 218. The constructions, functions, and effects similar to those of the first embodiment will not be described.

According to the present embodiment, as illustrated in FIG. 16, the positioning hole 226 has the clearances C1, C2 between two first sides 226S1 of the hole edge portion and two first sides 218S1 of the plate surface of the LED board 218, respectively. The positioning hole 226 has a Z-axis dimension opening width greater than the one of the positioning hole according to the first embodiment, and each of the clearances C1, C2 between the positioning hole 226 and the LED board 218 has an equal width. With such a configuration, the LED board 218 is attached to a heat dissipation member 220 so that each of the first sides 226S1 of the plate surface of the LED board 218 is set to be parallel to each of the first sides 226S1 of the hole edge portion of the positioning hole 226 and the two clearances C1, C2 has an equal width. Accordingly, the LED board 218 is positioned with respect to the heat dissipation member 220 in the Z-axis direction with high accuracy.

### Fourth Embodiment

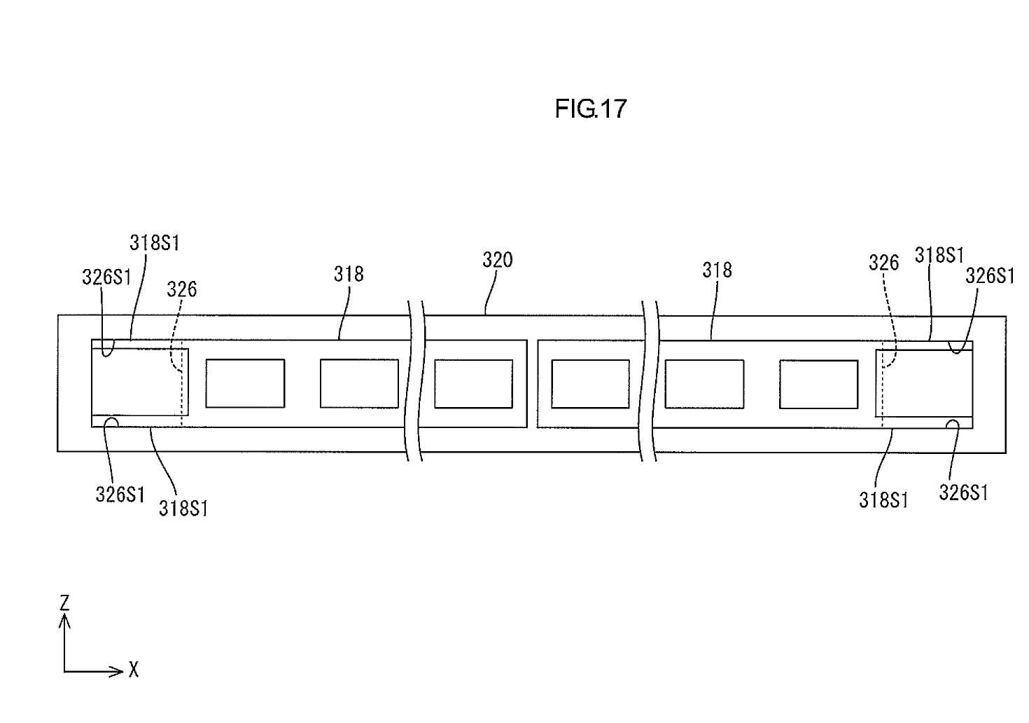

A fourth embodiment will be described with reference to FIG. 17. In the fourth embodiment, unlike the third embodiment, no clearance is provided between a positioning hole 326 and a LED board 318. The constructions, functions, and effects similar to those of the first embodiment will not be described.

According to the present embodiment, as illustrated in FIG. 17, the positioning hole 326 is formed so that two first sides 326S1 of the hole edge portion and two first sides 318S1 of a plate surface of a LED board 318 are positioned in lien with each other so as not to have any clearance therebetween. The positioning hole 326 has a Z-axis opening width dimension that is substantially same as a width dimension of the LED board 318. With such a configuration, the LED board 318 is attached to a heat dissipation member 320 so that each of the first sides 326S1 of the plate surface of the LED board 318 is set to be parallel to and positioned on each of the first sides 326S1 of the hole edge portion of the positioning hole 326. If any clearance is generated between any of the first sides 326S1, 326S1, it is confirmed that the position of the LED board 318 and the heat dissipation member 320 is shifted from the correct position. Therefore, the LED board 318 is positioned with respect to the heat dissipation member 320 in the Z-axis direction with high accuracy.

### Fifth Embodiment

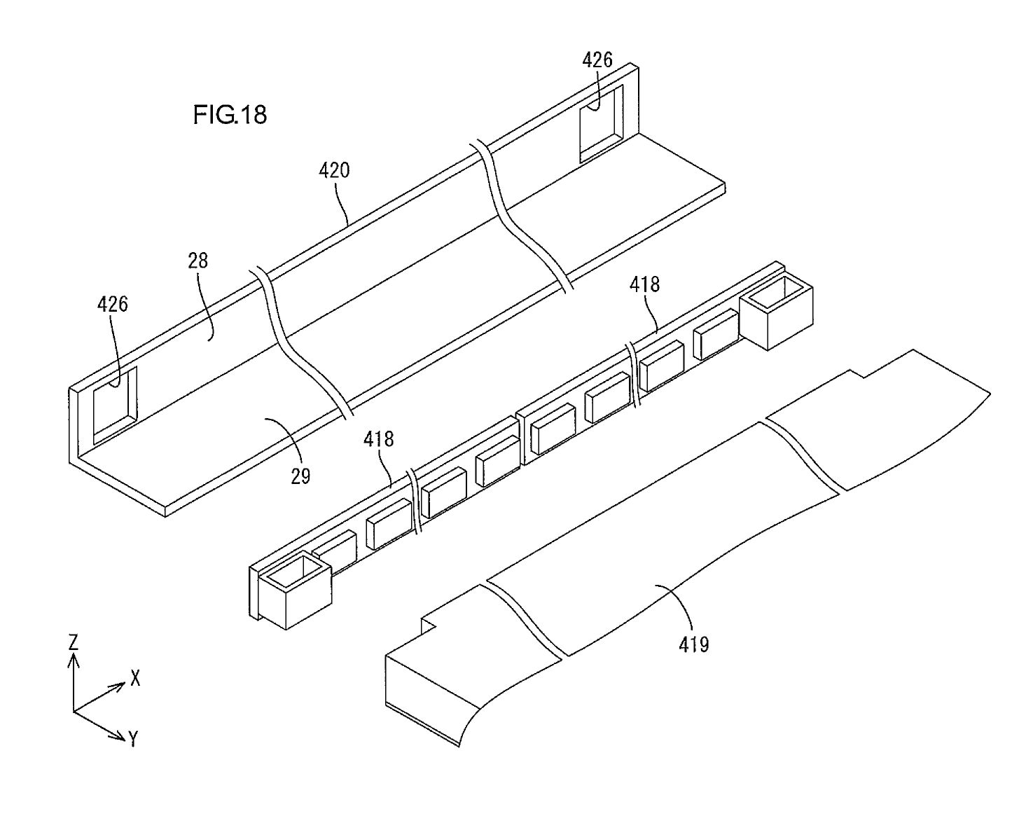

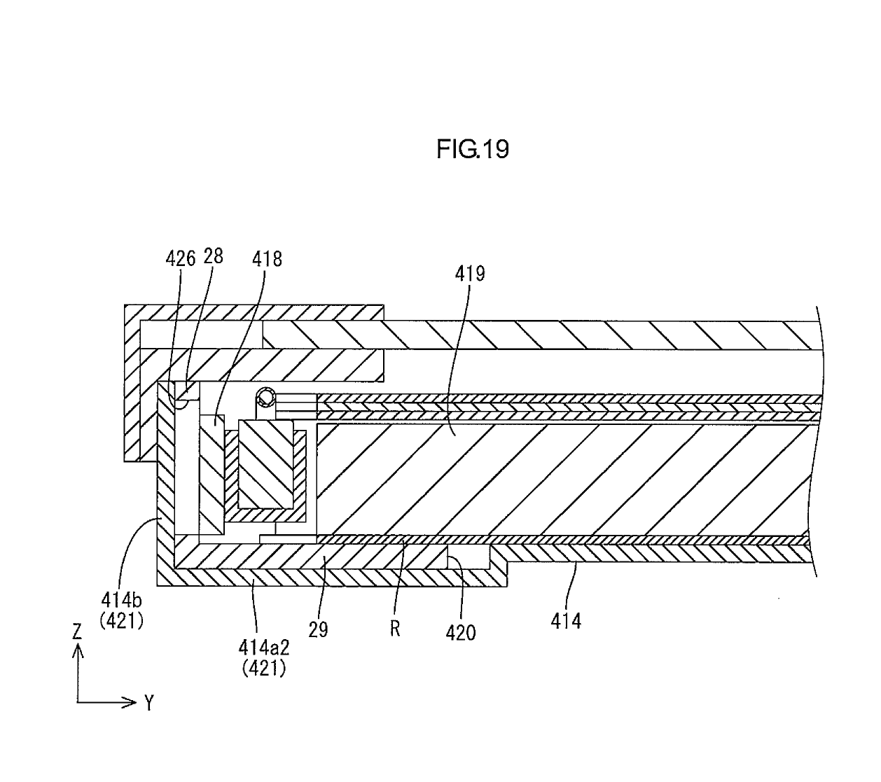

A fifth embodiment will be described with reference to FIG. 18 or FIG. 19. In the fifth embodiment, a heat dissipation member 420 has a different shape from the one in the above embodiments. The constructions, functions, and effects similar to those of the first embodiment will not be described.

According to the present embodiment, as illustrated in FIGS. 18 and 19, the heat dissipation member 420 is formed to be bent at a substantially right angle so as to follow the shape of a side plate 414b and a step portion 414a2 included in a LED container 421 of a chassis 414. The heat dissipation member 420 includes a LED board mounting portion 28 that extends along the side plate 414b and a bottom portion 29 that extends along the step portion 414a2. The heat dissipation member 420 has positioning holes 426 on respective two end portions of the longitudinal dimension (the X-axis direction) of the LED board mounting portion 28 where the LED board 418 is mounted. The positioning holes 426 are through the LED board mounting portion 28. The bottom portion 29 extends from a rear-surface side end of the LED board mounting portion 28 inwardly, that is, toward the LED board 418 and a light guide plate 419 and supports the light guide plate 419 and the reflection sheet R from the rear-surface side. Accordingly, a contact area between the heat dissipation member 420 and the chassis 414 is increased by the area of the bottom portion 29. Therefore, the heat is effectively transmitted from the heat dissipation member 420 to the chassis 414 and this improves a heat dissipation property.

### Sixth Embodiment

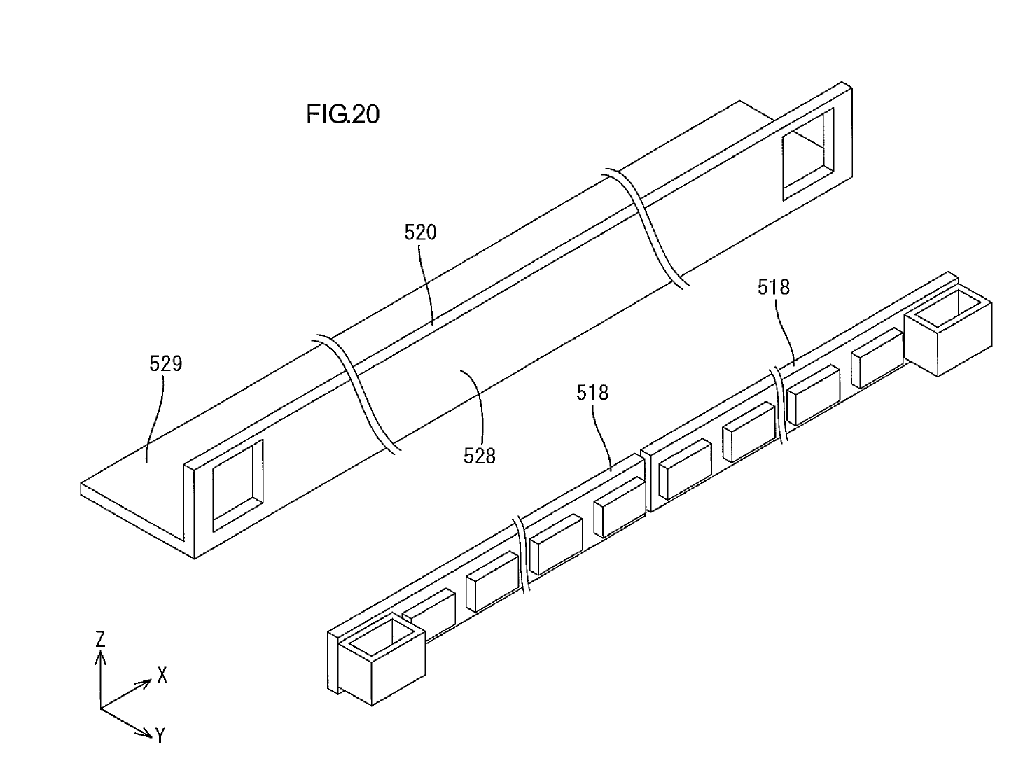

A sixth embodiment will be described with reference to FIG. 20. In the sixth embodiment, a heat dissipation member 520 has a different shape from the one in the fifth embodiment. The constructions, functions, and effects similar to those of the first embodiment will not be described.

According to the present embodiment, as illustrated in FIG. 20, the heat dissipation member 520 includes a LED board mounting portion 528 and a bottom plate portion 529. The bottom plate portion 529 extends from a rear-surface side end of the LED board mounting portion 528 outward, that is, toward an opposite side from a LED board 518 side. With such a configuration, the bottom plate portion 529 of the heat dissipation member 520 is attached to a step portion of a LED container included in the chassis, which is not illustrated.

### Seventh Embodiment

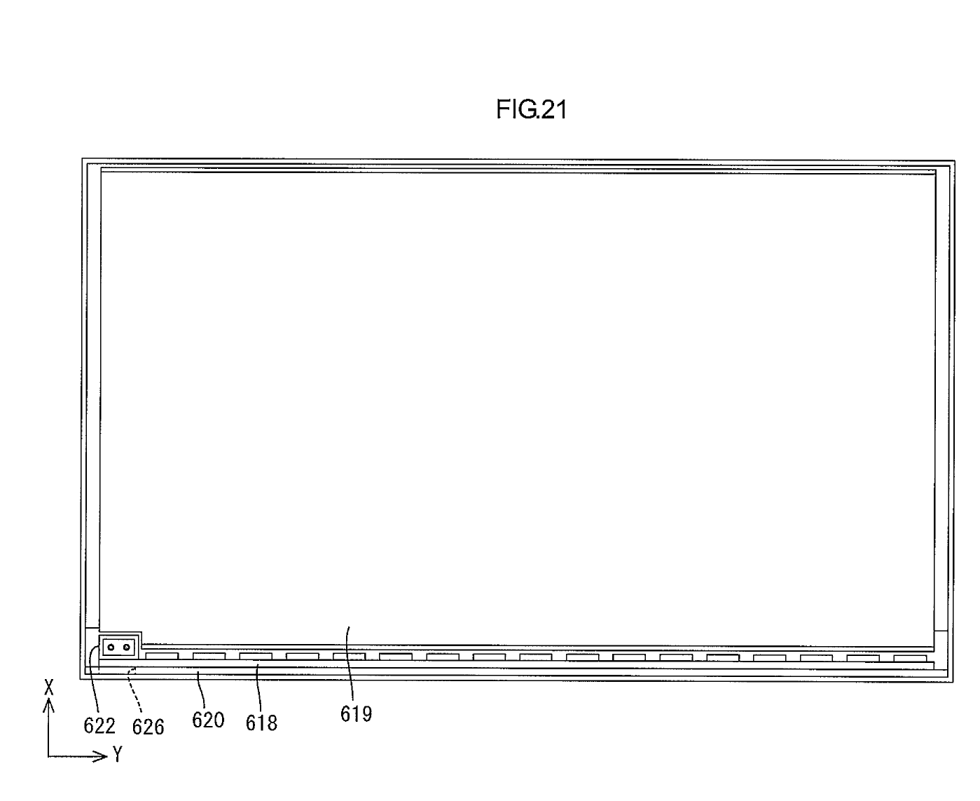

A seventh embodiment will be described with reference to FIG. 21. In the sixth embodiment, the number of LED boards 618 attached to a heat dissipation member 620 differs from that in the above embodiments. The constructions, functions, and effects similar to those of the first embodiment will not be described.

According to the present embodiment, as illustrated in FIG. 21, the heat dissipation member 520 includes only one LED board 618. The LED board 618 has a length dimension that is substantially equal to a long-side dimension of a light guide plate 619. Only one positioning hole 626 is formed in one end of the heat dissipation member 620 to be therethrough. The positioning hole 626 is formed to overlap a board-side connector 622.

### Eighth Embodiment

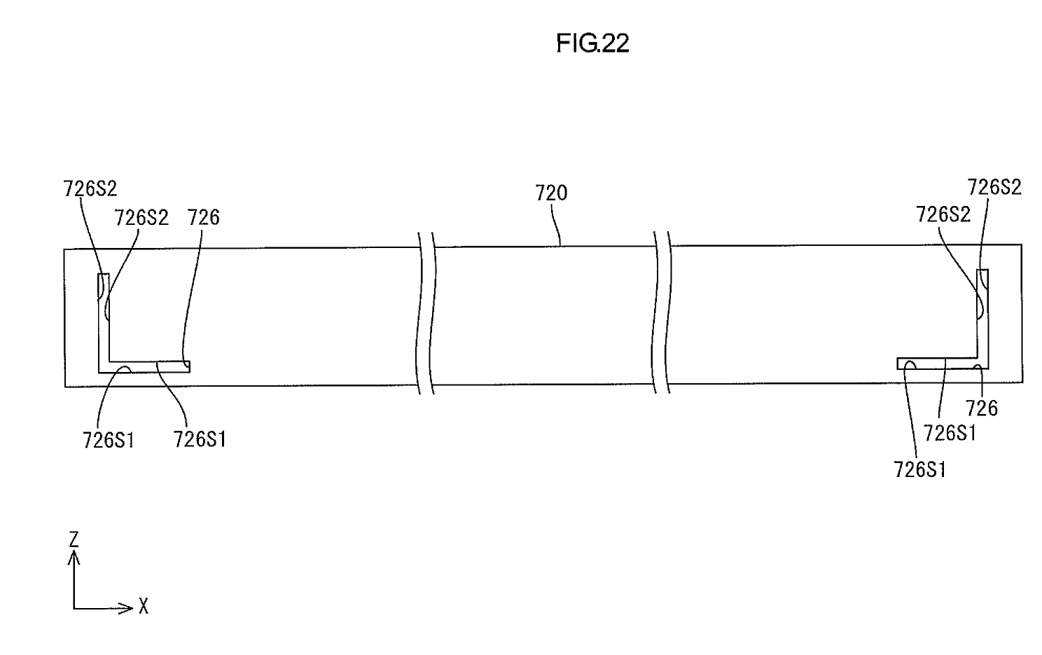

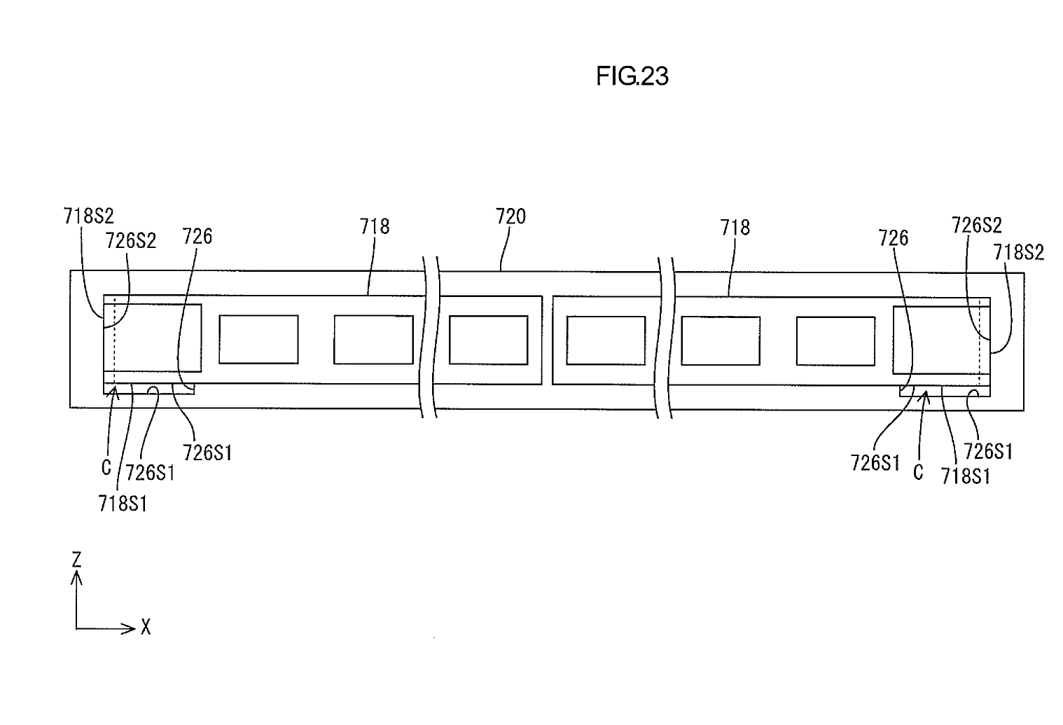

An eighth embodiment will be described with reference to FIG. 22 or FIG. 23. In the eighth embodiment, a positioning hole has a different shape from the one in the above embodiments. The constructions, functions, and effects similar to those of the first embodiment will not be described.

According to the present embodiment, as illustrated in FIG. 22, the positioning hole 726 is a substantially right-angled elongated thin slit having a substantially L-shape seen from a front side or a rear side. A hole edge portion of the positioning hole 726 includes two horizontal first sides 72651 that are parallel to the X-axis direction and two vertical second sides 726S2 that are parallel to the Z-axis direction. As illustrated in FIG. 23, a LED board 718 is attached to a heat dissipation member 720 so that a second side 718S2 of the LED board 718 is positioned on and overlaps the second side 726S2 of the hole edge portion of the positioning hole 726, and the second side 726S2 is the one closer to the end of the heat dissipation member 720. Further, the LED board 718 is attached to the heat dissipation member 720 so that a rear-surface side first side 718S1 of the LED board 718 is positioned on and overlaps a front-surface side first side 726S1 of the hole edge portion of the positioning hole 726. The LED board 718 is attached to the heat dissipation member 720 so as to have a clearance C between the rear-surface side first side 718S1 of the LED board 718 and the rear-surface side first side 726S1 of the hole edge portion of the positioning hole 726. The clearance C has a constant width over its entire length. With such a configuration, the LED board 718 is positioned with respect to the heat dissipation member 720 in the X-axis direction and the Z-axis direction with high accuracy.

### Ninth Embodiment

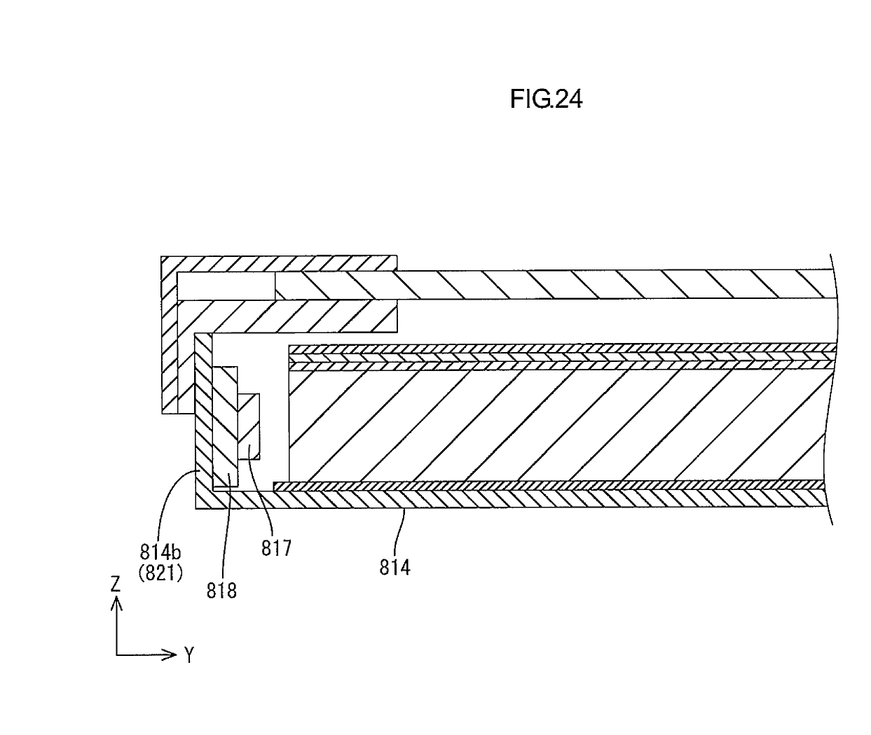

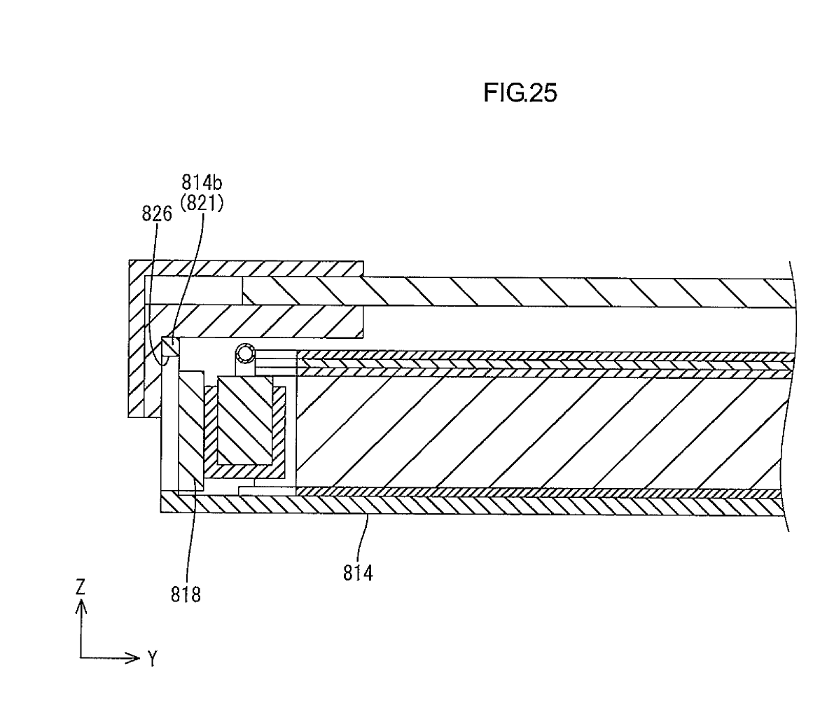

A ninth embodiment will be described with reference to FIG. 24 or FIG. 25. In the ninth embodiment, a device does not include a heat dissipation member. The constructions, functions, and effects similar to those of the first embodiment will not be described.

According to the present embodiment, as illustrated in FIGS. 24 and 25, a LED board 818 is directly mounted on a chassis 814 without having the heat dissipation member that is included in the first embodiment. The LED board 818 is mounted directly on a side plate 814b of a LED container 821 included in the chassis 814. Heat generated from LEDs 817 according to current applying is transferred to the side plate 814b via the LED board 818 and released via a chassis 814. According to the present embodiment, the chassis 814 constitutes a heat dissipation member that dissipates heat from the LEDs 817. The side plate 814b of a LED container 821 included in the chassis 814 has positioning holes 826 therethrough. The LED board 818 is positioned with respect to the chassis 814 by the positioning holes 826. The constructions, functions, and effects of the positioning holes 826 are similar to those of the first embodiment.

### Other Embodiments

The present invention is not limited to the above embodiments explained in the above description and the drawings. The technology described herein may include the following embodiments.

(1) In the above embodiments (except for the eighth embodiment), each of the hole edge portion of the square positioning hole and the LED board having a square plate surface has three sides that form two corner portions that are off-diagonal. The LED board is positioned with respect to the heat dissipation member by using the three sides. However, the LED board may be positioned with respect to the heat dissipation member using respective two sides that form one corner portion of each of the hole edge portion of the square positioning hole and the square plate surface of the LED board.

(2) In the above embodiments, the hole edge portion of the positioning hole and the plate surface of the LED board have second sides that are parallel to the Z-axis direction, and the second sides overlap each other. However, the LED board may be attached to the heat dissipation member so as to have a clearance between the two sides. In such a configuration, the LED board and the heat dissipation member may have a clearance between the first sides thereof that are parallel to the Z-axis direction and may have clearances between all the corresponding sides thereof.

(3) In the first embodiment, the LED board is attached to the heat dissipation member so as to have a clearance between the front-side first sides of the opening edge portion of the positioning hole and the plate surface of the LED board. However, the clearance may be provided between the rear-surface side first sides, and the LED board and the heat dissipation member may be positioned so that the front-side first sides overlap each other.

(4) In the eighth embodiment, the LED board and the heat dissipation member are positioned so have a clearance between the rear-surface side first side of the opening edge portion of the substantially L-shaped positioning hole and the rear-surface side first side of the plate surface of the LED board. However, the LED board and the heat dissipation member may be positioned so that the rear-surface side first sides may overlap each other and any clearance is provided between the LED board and the positioning hole. Alternatively, the LED board and the heat dissipation member may be positioned to have a clearance between the second sides.

(5) In the second embodiment, each of the first side and the second end of the hole edge portion of the positioning hole has the positioning piece. The positioning piece may be provided on the two first sides of the hole edge portion of the positioning hole and the second side that is close to the heat dissipation member and the total of three positioning pieces may be provided.

(6) In the second embodiment, each of the first side and the second end of the hole edge portion of the positioning hole has the positioning piece. The positioning pieces may be provided on each of the first side and the second side.

(7) In the above embodiments, the number of the positioning holes in the heat dissipation member is equal to the number of the LED boards that are attached to the heat dissipation member. The number of the positioning holes may not be equal to the number of the LED boards. For example, one LED board may be positioned by positioning holes or LED boards may be positioned by one positioning hole.

(8) In the above embodiments, the positioning hole has a square shape or a substantially L-shape seen from a front side or a rear side. The positioning hole may have any other shapes. For example, the positioning hole may have a horizontally long rectangular shape, a vertically long rectangular shape, a triangular shape, a trapezoidal shape, a pentagon shape or other polygonal shapes.

(9) In the above embodiments, the positioning hole is positioned to overlap the board-side connector with an substantially entire area thereof seen from a front side or a rear side. The positioning hole may be positioned to overlap a part of the board-side connector (for example, a half or one third of the board-side connector).

(10) In the above embodiments, the board-side connector is mounted on the mount surface of the LED board where the LEDs are mounted. The board-side connector may be mounted on a plate surface that is opposite from the mount surface of the LED board. In such a configuration, the board-side connector may be effectively arranged through the positioning hole.

(11) In the above embodiments, the LED board is attached to the heat dissipation member with an adhesive or a double-sided tape. The LED board may be attached to the heat dissipation member with screws or rivets.

(12) In the above embodiments, an example of the identification portion provided on the LED board includes a printed bar code. Examples of the identification portion include a two-dimensional codes, characters, numbers that may be printed.

(13) In the above embodiments, the LED board is attached to the heat dissipation member or the chassis. The LED board may be attached to a component other than the heat dissipation member or the chassis.

(14) In the above embodiments, one or two LED boards are arranged along the light entrance surface of the light guide plate. Three or more LED boards may be arranged along the light entrance surface of the light guide plate.

(15) In the above embodiments, the LED board is arranged to face a long-side end surface of the light guide plate. The LED board may be arranged to face a short-side end surface of the light guide plate.

(16) Other than the configuration of (15), the LED boards may be arranged to face the respective long-side end surfaces of the light guide plate or arranged to face the respective short-side end surfaces of the light guide plate.

(17) Other than the configurations of (15) and (16), the LED boards may be arranged to face any three end surfaces of the light guide plate, respectively or arranged to face all the four end surfaces of the light guide plate, respectively.

(18) In the above embodiments, the color filter of the liquid crystal panel includes the color portions of three colors including red (R), green (G), and blue (B). However, the color filter may include color portions of four colors or more.

(19) In the above embodiments, the LEDs are used as the light source. However, other light sources such as an organic EL diode may be used as the light source.

(20) In the above embodiments, the TFTs are used as switching components of the liquid crystal display device. However, the technology described herein may be applied to liquid crystal display devices including a liquid crystal display panel using switching components other than TFTs (e.g., thin film diodes (TFDs)). Furthermore, the technology may be applied to a liquid crystal display device including a black-and-white liquid crystal display panel other than a liquid crystal display device including a color liquid crystal display panel.

(21) In the above embodiments, the liquid crystal display device includes the liquid crystal panel as the display panel. However, the technology described herein may be applied to display devices including other kinds of display panels.

(22) In the above embodiments, the television device includes the tuner. However, the technology can be applied to display devices without including a tuner. Specifically, the technology can be applied to liquid crystal display devices that are used as digital signage or electronic black boards.

### EXPLANATION OF SYMBOLS

10: liquid crystal display device (display device), 11: liquid crystal panel (display panel), 12: backlight device (lighting device), 14, 414: chassis (casing member), 14a1: light guide plate support portion, 14b, 414b: side plate (heat dissipation member mount portion), 17, 817: LED (light source), 18, 118, 218, 318, 418, 518, 618, 718, 818: LED board (light source board), 18a: mount surface (plate surface), 18S1, 118S1, 218S1, 318S1, 718S1: first side (side), 18S2, 118S2, 718S1: second side (side), 19, 419, 619: light guide plate, 19a: light exit surface, 19b: light entrance surface, 19c: plate surface, 20, 120, 220, 320, 420, 520, 620, 720: heat dissipation member, 22, 622: board-side connector (power feed relay portion), 25: identification portion, 26, 126, 226, 326, 426, 626, 726, 826: positioning hole, 26S1, 126S1, 226S1, 326S1, 726S1: first side (side), 26S2, 126S2, 726S2: second side (side), 27: positioning piece, 814: chassis (heat dissipation member), C: clearance, C1: clearance, C2: clearance, TV: television device

1. A lighting device comprising:
a light source;
a light guide plate having an end surface as a light entrance surface and a plate surface as a light exit surface, the light entrance surface through which light from the light source enters the light guide plate, and the light exit surface through which the light exits the light guide plate;
a light source board having a plate surface where the light source is arranged and that is opposed to the light entrance surface and has a square shape;
a power feed relay portion arranged on the light source board and that relays power feed to the light source; and
a heat dissipation member where the light source board is arranged and configured to dissipate heat generated from the light source, the heat dissipation member having a positioning hole that is through the heat dissipation member and with which the light source board is positioned with respect to the heat dissipation member, and the positioning hole corresponding to the power feed relay portion, the heat dissipation member having a hole edge portion around the positioning hole and the hole edge portion including two sides constituting a corner portion, the two sides being parallel to two sides of the plate surface of the light source board, respectively, and the two sides of the light source board constituting a corner portion of the plate surface of the light source board.

2. The lighting device according to claim 1, wherein
the light source board includes an identification portion on the plate surface that is opposed to the heat dissipation member, the identification portion including identification information relating to the light source board, and
the identification portion is arranged in the positioning hole.

3. The lighting device according to claim 1, wherein
the two sides constituting the corner portion of the hole edge portion of the positioning hole are positioned on the two sides of the plate surface of the light source board.

4. The lighting device according to claim 1, wherein
the hole edge portion of the positioning hole has a square shape having four corner portions, and
three sides constituting off-diagonal two corner portions among the four corner portions are parallel to three sides constituting off-diagonal two corner portions of the plate surface of the light source board, respectively.

5. The lighting device according to claim 4, wherein
one of the three sides constituting the two corner portions of the hole edge portions of the positioning hole is away from the light source board with a clearance.

6. The lighting device according to claim 5, wherein
two of the three sides constituting the two corner portions of the hole edge portion of the positioning hole are opposed to each other, and
one of the two sides is away from the light source board with the clearance, and another one of the two sides is positioned on one of the three sides constituting the two corner portions of the plate surface of the light source board.

7. The lighting device according to claim 1, wherein
the plate surface of the light source board has a rectangular shape and has a short-side direction that matches a thickness direction of the light guide plate and a long-side direction that matches a direction perpendicular to the thickness direction of the light guide plate, and
the light source includes light sources that are arranged on the light source board along the long-side direction and each of the light sources does not overlap the positioning hole.

8. The lighting device according to claim 7, wherein
the light source board includes light source boards that are arranged linearly along the long-side direction and mounted on the heat dissipation member.

9. The lighting device according to claim 1, wherein
the power feed relay portion is arranged on the light source board to be opposed to an end portion of the light guide plate.

10. The lighting device according to claim 1, further comprising a casing member, the casing member including:
a light guide plate support portion configured to support a plate surface of the light guide plate opposite from the light exit surface; and
a heat dissipation member mount portion where the heat dissipation member is mounted.

11. The lighting device according to claim 1, wherein
the hole edge portion of the positioning hole includes at least two positioning pieces that are parallel to the respective two sides constituting the corner portion thereof and the positioning pieces contacting the light source board.

12. A display device comprising:
the lighting device according to claim 1; and
a display panel displaying with using light from the lighting device.

13. The display device according to claim 12, wherein the display panel is a liquid crystal panel including a pair of substrates and liquid crystals enclosed therebetween.

14. A television device comprising the display device according to claim 12.
